(19) United States
(12) Patent Application Publication
(10) Pub. No.: US 2002/0189998 A1
(43) Pub. Date: Dec. 19, 2002

(54) Processes and apparatus for potable water purification that include bio-filtration, and treated water from such processes and apparatus

(76) Inventors: Richard A. Haase, Sugar Land, TX (US); Audrey L. Haase, Sugar Land, TX (US)

Correspondence Address: J.M. (Mark) Gilbreth, Gilbreth & Associates, P.C., P.O. Box 2428, Bellaire, TX, 77402-2428, US

(21) Appl. No.: 10/117,682

(22) Filed: Apr. 5, 2002

Related U.S. Application Data
(63) Continuation of application No. PCT/US01/10426, filed on Apr. 2, 2001.
(60) Provisional application No. 60/194,151, filed on Apr. 3, 2000.
(60) Provisional application No. 60/254,957, filed on Dec. 12, 2000.

(51) Int. Cl. C02F 3/00

(52) U.S. Cl. 210/611

(57) ABSTRACT

An improved bio-filter system is presented for purifying potable water comprising locating at least one bio-filter structure upstream of a disinfecting unit in a potable water purifying plant and colonizing fermentation-raised bacteria on or within the at least one bio-filter structure and including the at least one bio-filter structure having the fermentation-raised bacteria. Improved potable water treatment processes are presented comprising the elimination of oxidation/disinfection prior to coagulation. Improved potable water treatment processes are presented utilizing oxidation/disinfection with ozone in the purifying process upstream of bio-filtration. Biofiltration is then followed by final filtration and final disinfection. By utilizing a new coagulation technology, separation of solids (including TOC and Dissolved organic carbon) from potable water is improved. This new coagulation technology is preferred to be used along with ozonation upstream of bio-filter(s) colonized with fermentation-raised non-ubiquitous bacteria. This new coagulation technology is most preferred to be used with the new bio-filter(s) colonized with fermentation-raised non-ubiquitous bacteria; this combination can replace ozonation.

### RELATED-APPLICATION DATA

This application is a Continuation of copending International Patent Application PCT/US01/10426, with International Filing Date Apr. of 2, 2001, published in English under PCT Article 21(2) as WO 01/74725 on Oct. 11, 2001, which claims priority of U.S. Provisional Patent Application Serial No. 60/194,151 filed Apr. 3, 2000 and of U.S. Provisional Patent Application Serial No. 60/254,957 filed Dec. 12, 2000.

### BACKGROUND OF THE INVENTION

1. Field of the Invention

The present invention relates to processes and apparatus for water treatment, and to treated water produced by such processes and apparatus. In another aspect, the present invention relates to processes and apparatus for producing potable, drinking, water, and to potable, drinking water produced by such processes and apparatus. In even another aspect, the present invention relates to processes and apparatus for removing Total Organic Carbon (“TOC”) as well as reducing the concentration of pathogens and viruses from water, especially water produced in a potable water treatment plant, and to treated water produced by such processes and apparatus. In still another aspect, the present invention relates to processes and apparatus for reducing the aluminum content in drinking water, and to treated water produced by such processes and apparatus. In yet another aspect, the present invention relates to processes and apparatus for reducing the concentration of disinfection by-products, especially those that are toxic, carcinogenic and/or teratogenic in water, especially potable water, and to treated water produced by such processes and apparatus. In even still another aspect, the present invention relates to processes and apparatus for reducing the concentration of compounds that produce “Taste” and/“odor” issues in water, especially drinking water.

2. Description of the Related Art

Mankind, has over the centuries, attempted to produce a drinking water of improved quality. Many of those attempts have later proven to be worse than the problems that the attempt was trying to correct. Examples would be: over treatment with alum since the time of the Egyptians which is linked to Alzheimer's Disease, asbestos piping which speaks for itself, chlorination or bromination creating carcinogenic and teratogenic disinfection by-products, final NTU operation over 0.3 allowing pathogenic and viral contaminants that are resistant to chlorine to enter the water supply, i.e. Cryptosporidium and Giardia.

TOC is defined as total amount of organic carbon, and as is understood to refer to organic molecules, compounds, not free carbon or carbon salts. TOC may consist of various organic molecules, which can be classified into, or in this invention are helpfully distinguished into, the categories of Insoluble Organic Carbon (“IOC”) and Dissolved Organic Carbon (“DOC”). IOC molecules are generally non-polar long chain organic molecules. As used herein, “long chain” refers to a carbon chain length of at least 4 carbons, and “short chain” refers to a carbon chain length of less than 4 carbons. At least for potable drinking water purposes, DOC molecules are either short chain (polar or nonpolar) organic molecules or long chain polar organic molecules. For polar organic molecules, the degree of water solubility is directly related to the degree of polarity. The degree of water solubility is usually expressed in percentage terms for polar organic molecules and in terms of mg/L for short chain non-polar organic molecules.

For clarity and definition, DOC is defined in this specification as previously described, and not as defined by the standard industry laboratory test which analytically defines DOC as measurable TOC from a water sample that has been passed through 0.34-micron filter paper.

Because of their insolubility, IOC compounds and molecules, can be removed via coagulation and flocculation. Being insoluble, an IOC molecule develops a negative columbic charge that allows a cationic coagulant to remove the insoluble molecule from the water. In the case of the short chain and/or polar DOC molecules, this does not happen. These DOC molecules are difficult to remove via coagulation and flocculation because of their solubility. By being soluble, DOC molecules do not develop a negative columbic charge; therefore, cationic coagulants are less able to remove DOC molecules from the water. Furthermore, if the TOC molecules, IOC and DOC, are small and/or low in concentration the kinetics required to bring the coagulant in contact with the TOC molecules translates to a very high mixing energy. This kinetic requirement becomes important when one takes into account that, in drinking water production facilities, TOC is measured to an accuracy of fractional ppm in concentration.

Some DOC compounds are inherently toxic. Examples would be methyl-tertiary-butyl-ether (“MTBE”), aldehydes and ketones. Such toxic DOC molecules, compounds, can be contaminants in the water from either man-made or natural polluting sources. Some toxic DOC molecules are even “disinfection by-products” (discussed below) of the drinking water purification process itself, examples of which include aldehydes and ketones produced by the ozonation process.

In addition, some DOC molecules which are not necessarily toxic at certain concentrations, are none-the-less aesthetically objectionable (i.e., because of taste and/or odor). For example, Geosmine and MIB are two such molecules, which at low concentrations are not toxic, but are otherwise objectionable for contributing undesirable taste and odor characteristics to drinking water.

One purpose of a drinking water facility is to remove bacteria and viruses from the water, and another is to protect against biological contamination reoccurring in the treated water. Bacteria removal and protection against contamination reoccurrence is accomplished with the addition of disinfectants. The disinfection of water is usually accomplished with chlorine, chloramines, chlorine dioxide or ozone. To protect against biological cultures growing in the storage tank(s) or in the distribution system, thereby re-contaminating the water, chlorine or chloramines are utilized at a level to maintain a residual chlorine concentration of 1 to 4 ppm.

Proper disinfection requires a mixing time or contact time (“CT”) that is a requirement of the disinfectant to kill the naturally occurring bacteria and viruses. The United States Environmental Protection Agency (“EPA”) has required disinfection contact times that are termed “CT Credits”; each disinfectant has its own required CT to obtain the required CT Credit.

In recent years, research has concluded that the disinfection of drinking water by chlorine can itself create “disinfection by-products.” which may be carcinogenic (i.e., cancer causing) and/or teratogenic (i.e., causing birth defects in unborn children when the mother consumes such molecule(s) during pregnancy) molecules. For example, carcinogens and teratogens can be created if halogens, usually chlorine, attach to a hydrocarbon in the water by the halogen substitution reaction.

The halogen substitution reaction involves reacting in the drinking water, organic molecules with a halogen disinfectant, for example chlorine. As nearly all disinfectants are neucleophiles, this substitution reaction typically occurs via the neucleophillic substitution pathway.

A “disinfection by-product” is formed by a first reaction of a disinfectant, usually chlorine or ozone, onto an organic molecule that is a precursor to the final “disinfection by-product”. The EPA has already targeted certain “disinfection by-products”, the tri-halo-methane's (“THM's”) and the halo-acetic acids (“HAA's”), as specifically harmful molecules that must be in concentrations of less than 64 ppb and 48 ppb, respectively, in the final drinking water. THM's are documented carcinogens and HAA's are documented teratogens.

While a strong disinfectant tends to require a short CT time to obtain CT Credits, weak disinfectants tend to require a long CT time to obtain their associated CT Credit. Unfortunately, it is the stronger disinfectants requiring the shortest CT that tend to also the strongest neucleophiles. Conversely, the weaker neucleophiles tend to be the weakest disinfectants requiring the longest CT. Therefore, as the water production facility attempts to reduce the formation of disinfection by-products by reducing the neucleophillic capability of the disinfectant, the required CT increases. To meet the required CT with a disinfectant that will minimize the formation of disinfection by-products and avoid potentially expensive contact tanks downstream of filtration, many facilities in recent years have begun to disinfect in separation. This practice has an additional benefit of controlling algal growth in the separation equipment. Further, it has been determined that algae secrete TOC molecules into the water that cause “Taste & Odor” issues in the final water; therefore, the elimination of algae in separation also helps to control “Taste & Odor” issues in the final water.

Water production facilities normally consist of seven stages: Stage 1. Pre-treatment, Stage 2. Coagulation, Stage 3. Flocculation, Stage 4. Separation, Stage 5. pH adjustment and Disinfection, Stage 6. Filtration, and Stage 7. Storage. A brief description of the typical seven stages follows.

Stage 1 Pre-treatment is not always performed, yet may consist of: aeration, KMNO₄ treatment, powdered activated carbon treatment, ozone treatment, chlorine dioxide treatment, chloramine treatment and very infrequently chlorine treatment.

Stage 2 Coagulation consists of coagulant addition and high speed mixing of the coagulant into the water creating microfloc.

Stage 3 Flocculation consists of slow mixing and the growing of microfloc into macrofloc. Often flocculation will include the addition of a flocculent.

Stage 4 Separation is the separation, usually by gravity settling, of a macrofloc formed in flocculation from the water. The macrofloc is usually removed at the bottom of a clarifier while the clarified water flows over the weirs of the clarifier. Separation can also occur by centrifugation, air flotation or filtration. However, gravity separation is the most popular.

Stage 5 pH Adjustment is accomplished with either lime or caustic. Disinfection is typically accomplished with chlorine dioxide, ozone, chloramines or chlorine.

Stage 6 Filtration, the clarified water typically then flows through an anthracite and/or sand filter media to perform filtration. In recent years, membrane and Zeolite filtration have become popular. In regard to final filtration, in order to reduce the possibility of viral or pathogenic cultures remaining in the final water, the USEPA is “recommending” that final filtered turbidities measure 0.1 NTU or less. At this time, to reduce the risk of pathogenic or viral cultures in the final water, the USEPA is “mandating” that final filter turbidities be reduced to less than 0.3 NTU.

Prior to Stage 7 Final Storage, either after filtration and/or prior to filtration, chlorine or chloramines are added to disinfect the water from biological contamination, as well as to prevent biological accumulation in the storage tank(s) and in the distribution system.

A thorough review of a water treatment facility can be obtained from many textbooks, which may include “Water Supply and Pollution Control,” by Clark, et. al., “Water Quality and Treatment,” by The American Water Works Association, “Coagulation,” by The American Water Works Association and “Optimizing Water Treatment Plant Performance Using the Composite Correction Program,” by the USEPA.

Nearly all water production facilities have a well-managed coagulation, flocculation and separation system. The removal of IOC molecules is performed effectively in these systems. Therefore, the pernicious precursors to “disinfection by-products” are primarily the DOC molecule(s). Thus, it is important to remove DOC molecules to effectively remove the organic molecules that are precursors to “disinfection by-products”.

Coagulation and flocculation technologies, including newer technologies disclosed U.S. Pat. No. 6,120,690 and International Patent Application No. PCT/US99/18338, have shown to be effective at removing the IOC component of TOC. However, there is no known practical method of coagulation and flocculation to remove DOC effectively, as discussed above. The most difficult DOC molecules are the very small molecules, having a carbon chain of 1 to 3 carbon atoms, leaving the kinetics required to bring a coagulant in contact with such small molecules generally beyond the scope of the current equipment in most drinking water facilities. As discussed above, DOC molecules have no columbic charge; therefore, there is no ionic driving force to attach DOC molecules to the coagulant.

In addition, treatment primarily with aluminum salts, alum or aluminum chloride, lead to the existence of soluble aluminum in the final water product. Aluminum is linked to Alzheimer's disease. Many states have imposed aluminum content limits, which effectively eliminates over treatment with aluminum salts and in many cases eliminates aluminum as an option in water clarification systems.

To remove “disinfection by-product” precursors that cannot be removed by normal coagulation and flocculation, which, as discussed above, is typically the DOC component of TOC, many water production facilities are investing in ozone production plants for on-site ozone production and pretreatment of the raw water. Ozone primarily converts the TOC, IOC and DOC, molecules to alcohols and glycols. These alcohols and glycols, termed “Assimulatable Organic Content” (“AOC”), are polar; and therefore, also tend to also be DOC molecules. Unfortunately, ozone also converts a fraction of the DOC molecules to toxic aldehydes and ketones. Typically, ubiquitous bio-filters are established downstream of the ozone treatment to consume the AOC. A final disinfection follows.

“Ubiquitous bacteria” refer to bacteria that are historically and normally present in the raw water of the drinking water purification stream. Such bacteria have been considered inherently safe for biological filter activity since these bacteria are normally and historically present in the water shed. A ubiquitous biological filter is a biological filter structure designed to permit colonies of ubiquitous bacteria to colonize and populate, consuming a substrate. The substrate is the food source of bacteria. The ubiquitous bacteria present in the filter of an ozone treatment plant are present to consume the AOC created by ozonation. Again, ozonation enhances the amount of AOC present, through conversion of TOC. Upon the ubiquitous bio-filter, colonies of ubiquitous bacteria consume the enhanced level of AOC. Unfortunately, the ubiquitous bacteria have a limited ability to consume the toxic TOC molecules.

Because ozone is an expensive chemical to manufacture, water production facilities that install ozone generators significantly increase the cost of water production. Also, ozone has its own set of toxic “disinfection by-products”, some of which are aldehydes and ketones. These “disinfection by-products” of ozonation, specifically aldehydes and ketones, are currently under investigation by the EPA. While the US EPA's stated goal is the reduction of TOC to 2 mg/L or less prior to disinfection, many facilities that have installed ozonation are yet unable to remove DOC to a concentration of 2 mg/L or less.

As mentioned above, for DOC removal, ozonation facilities add a ubiquitous biological filter. The filter structure is usually upstream of the final filter. Typically, granular activated carbon (“GAC”) is added to the upstream portion of a final anthracite filter to provide a ubiquitous biological filter structure. Disinfection in such designs is moved downstream to the final filter or after the final filter, permitting ubiquitous biological cultures to grow on the GAC filter media.

However, this ozone-operating scenario has operational risks. Filters with ubiquitous biological cultures can enhance the risk of waterborne disease in the final water. If harmful waterborne diseases persist as part of the ubiquitous bacteria in a clarified water stream of a purification facility or any plant utilizing a ubiquitous biological filter, there would be a natural enhancement, accumulation and colonization of these diseases or viruses on the biological filter itself, along with the other ubiquitous bacteria. Should there then be a turbidity breakthrough in combination with a loss of disinfection downstream, there exists a potential scenario for these waterborne diseases contained in the ubiquitous filter along with the other harmless bacteria to be carried into the final water to the citizens. (A filter turbidity breakthrough is defined as the filter allowing water to pass in which the turbidity of that filtered water is in excess of the maximum turbidity target of that filter.

Ubiquitous biological filters in an ozonated water purification plant are inoculated by the available bacteria from the clarifier. Such bacteria have been regarded as inherently safe for colonization, having historically been present to some extent (although such is not necessarily guaranteed 100% of the time, as per the above discussion.). Since the inherent goal of the upstream clarification system is to remove turbidity, the inherent goal of the upstream clarification system is to remove bacteria. Therefore, the cultures available in the water downstream from the clarifier are few. Normally, 4 to 6 months of operation are therefore required to effectively inoculate a ubiquitous biological filter. This causes further operational issues. Filters, including biological filters, must be periodically cleaned. The typical cleaning method is by backwash. In the case of the ubiquitous biological filter, if the water production facility cleans the filter by backwashing with chlorinated water, then the facility faces a long period before the biological filter is again inoculated with ubiquitous bacteria. Since such repeated delays are basically untenable, the water production facility will likely backwash and clean the biological filter(s) with non-chlorinated water. Cleaning the biological filter with non-chlorinated water allows any pathogenic ubiquitous bacteria or viruses, which happen to have arisen, to continue and to flourish. As a further limitation of ubiquitous biological filters, the water production facility is unable to rapidly increase the biological population of a ubiquitous bio-filter should either the plant throughput increase or the TOC concentration increase in the clarified water. Since water production throughput is seasonal and raw water quality is often variable, ubiquitous biological filters cannot perform reliably on a continual basis.

Moreover, since ubiquitous biological filters are inoculated with the available bacteria that pass through the upstream clarifier, toxic DOC and IOC molecules that are not converted to AOC by ozonation and that enter the bio-filter will likely also pass through the bio-filter. This is because the ubiquitous bacteria have not been specifically cultured to consume these toxic molecules. Rather, the job of the ubiquitous bacteria has been to consume the glycols and alcohols produced by the ozone's conversion of TOC, as well as DOC. While nature can and may produce biological cultures that will consume these toxic organic molecules over time, nature's time frame to produce new cultures is measured in years and often in decades.

DOC molecules that cause taste and/or odor in drinking water, such as Geosmine and MIB, are currently removed by either ozonation in combination with ubiquitous biological filters or potassium permanganate in combination with powdered activated carbon.

Europe and other parts of the world are known to utilize ubiquitous bio-filters without ozonation in drinking water purification systems. Their results have been mixed. While the typical DOC molecule is non-toxic and thereby can be a readily assimulatable substrate for a ubiquitous bio-filter, bio-filters are often unable to remove toxic TOC molecules. In addition, these bio-filters are often unable to increase in biomass quickly enough to adapt to changing water conditions.

Wastewater treatment facilities, that do not have the limitation of having to produce potable water, are known to use fermentation-raised biological cultures. The strain(s) utilized are identified or selectively cultured for their ability to consume specific substrates. Such bacteria have been used in wastewater treatment facilities since the Clean Water Act of 1974. Incorporating bacteria, wastewater treatment plants utilize aeration basins and activated sludge systems to remove Chemical Oxygen Demand (“COD,” is a measure of the amount of a predefined oxidative chemical blend that oxidizes the organics in a water sample, measured in ppm of the oxidative chemical blend consumed.) and Biological Oxygen Demand (“BOD,” a measure of the capability of a ubiquitous bacterial blend to consume the substrates in a water sample. , measured by the amount of oxygen demanded by the bacteria.). While most wastewater plants remove BOD to 30 ppm and less, most wastewater plants only remove COD to levels of 200 ppm and less. However, in the case of a drinking water plant, the final TOC concentration is an order of magnitude lower; a drinking water plant needs to reduce TOC to 2 ppm and less. The difference in COD and BOD is usually an indication of the percentage of organics, or TOC, in a water that cannot be removed by ubiquitous biological cultures.

Wastewater treatment plants are known to contain a high level of pathogenic bacteria and viruses. Even though such bacteria and viruses are targeted to be killed prior to discharge of the treated water into the environment, as a matter of prudent practice a wastewater treatment plant is never directly connected to a drinking water plant.

In a drinking water, potable water, plant, the concept of adding any bacteria, ubiquitous or otherwise, to the purification process has been inherently rejected. As of the filing date of this application, no U.S. federal or state agency approves of the adding of any non-ubiquitous bacteria to a drinking water purification stream. NSF International, the organization that certifies and lists certified water treatment additives, does not have any certification or listing of biocultures in drinking water.

Since one purpose of a drinking water facility is to remove bacteria and viruses from the water, that purpose alone makes the proposal of the importation of external fermentation-raised bacteria into the drinking water purification stream novel and unexpected. Although ubiquitous bacteria and biological filters have been used to clean drinking water, and fermentation-raised bacteria has been used to clean ponds and aquariums and wastewater, the concept of intentionally inoculating a drinking water plant with extra non-naturally occurring, non-ubiquitous, fermentation-raised bacteria is against conventional wisdom. As mentioned above, currently the world organization that approves the equipment and additives used in drinking water handling and treatment, NSF International, does not have any bacteria certified or listed for use, much less have a program for biological listings.

A further reason why a significant amount of effort has been required to obtain any acceptance of the concept is that bio-filters perform poorly on chlorinated (or halogenated) substrate(s). Prior to the recent advent of significantly improved coagulation and flocculation technology, drinking water was pretreated with an oxidizer (typically chlorine, sometimes ozone) to enhance coagulation and flocculation as a matter of course. Bio-filters typically perform poorly with halogenated substrate(s). Recent improvements in coagulation and flocculation technology, as for instance disclosed in U.S. patent application Ser. No. 09/675,695, filed Sep. 29, 2000, incorporated herein by reference, renders such oxidation by chlorination, ozonation and the like unnecessary. Thus, the door is now further opened for use of a subsequent fermentation-raised bio-filter.

At this time, many water production facilities have to choose between the expense of an ozone system, with its inherent operating risks and inefficiencies involved on the one hand, and the possible production of toxins, carcinogens or teratogens on the other hand. Providing more pressure on the industry, the EPA has imposed stricter operating guidelines on water production facilities, including the removal of “disinfection by-product” precursors, namely TOC, and including new water turbidity rules and “disinfection by-product” rules. Current TOC removal targets of the EPA are based upon raw water TOC and alkalinity. The stated goal of the EPA is to remove TOC to less than 2 mg/L in all drinking water facilities prior to disinfection.

As a final complication, it is suspected that many water sources are increasingly becoming contaminated with toxic sources of DOC, along with the contamination of purified water by man made disinfection by-products. Therefore, what is needed in the drinking water industry at this time is a cost effective, efficient method of removing TOC, specifically the DOC component of TOC, along with the toxic TOC molecules, before disinfection.

There are perceived risks as well as psychological blocks associated with the addition of non-ubiquitous biological cultures to a drinking water plant. These perceived risks and psychological blocks are one reason why this concept has not been entertained in the past, and why a significant amount of effort has been required to obtain any acceptance of the concept at the regulatory level, at NSF International and at a few potential customer sites where the concept has been introduced.

Psychologically, the objective of a drinking water plant is to remove bacteria from the water. Known and published cases of Cryptosporidium, Giardia, fecal and other pathogenic or viral contaminations that were not removed properly from drinking water generate an instinctive abhorrence in drinking water plant management associated with any suggestion of “adding” any bacteria to a drinking water purification system. (Ubiquitous bacteria, at least, are not purposefully “added”.) It is feared that an aggressive biological filter would provide an environment for pathogenic and viral cultures to thrive. It is feared that unforeseen operational challenges might allow pathogenic and/or viral cultures to pass into the drinking water. It is feared that fermentation-raised biological cultures could inadvertently contain pathogenic or viral cultures. It is feared that by fermenting and selectively culturing, those pathogenic or viral cultures could be more prolific than would have otherwise been the case with ubiquitous biological cultures.

Realistically accessing conventional potable water treatment processes, however, shows that the risks to health here are likely far greater than is commonly acknowledged. For instance, it is unrealistically believed that ozonation only produces biologically AOC, and that ubiquitous biological cultures can adequately remove that AOC product. It is unrealistically believed that the disinfectant process of ozonation is such a good disinfectant process that ozonation will kill all pathogens and viruses while at the same time will allow enough bacteria to pass through the plant so that ubiquitous biological filters will be adequately inoculated with ubiquitous bacteria available from ozonation. The reality is, as is readily known by those of skill in the art of chemistry and as is currently being documented in the trade literature, that ozone produces its own set of disinfection by-products that are toxic and carcinogenic. Unfortunately, those disinfection by-products tend to be so toxic that ubiquitous bacteria cannot use those disinfection by-products as a substrate. In some cases, those disinfection by-products are disinfectants in their own right. Further, this concept of inoculating a biological filter from clarification and especially from an ozonation process is proving not to make practical sense. The best method of inoculating the biological filter is proving to be by operating the clarification and ozonation process out of specification.

One aspect of the instant invention is realistically addressing the above risks, perceived, real and psychological blocks, and concluding that utilizing fermentation-raised biological cultures (with thoughtful safeguards) as well as selectively cultured fermentation-raised biological cultures is less risky on the whole than conventional systems. Addressing the psychological blocks, it can be pointed out that not all bacteria are harmful. Human beings have bacteria on their skin for protection and in their intestines to aid in the digestive process. Without helpful bacteria, humanity could not survive. Viewing bacteria in general as a significant asset rather than as a danger helps address the psychological blocks. More important, in regard to thoughtful safeguards it has been learned by testing that the more aggressive specifically chosen larger heterotrophic bacteria out-compete and even consume many of their pathogenic and viral counterparts. In addition, these heterotrophs, being much larger in size than their pathogenic and viral counterparts, are much less likely to pass through any final filter media. By limiting the fermentation process to the use of known and identified harmless bacterial strains, and then performing extensive quality checks as to the final biological content of the fermentation-raised product, one can further reduce any risk of harmful bacteria in a biological filter. The risk with fermentation-raised biological cultures should be able to be shown to be realistically less than the risk present with ubiquitous biological cultures. Further, limiting the fermentation-raised biological cultures to those that are very susceptible to disinfection by chlorine reduces any risk to an extremely low level that, in the event of an operating challenge, any bacteria would be delivered in the drinking water. Any fermentation-raised biological cultures would almost completely be disinfected from the water with the chlorine.

At this time, billions of dollars have been spent on ozonation equipment. While ozone has its benefits, its weakness is that it creates toxic DOC molecules. While ubiquitous biological filters have their benefits, weaknesses include operating control and the potential of pathogenic and viral colonization on the media. And finally, use of ozone in concert with ubiquitous biological filters, includes the as weaknesses just presented along with the potentiality of passing AOC molecules on to disinfection when the bio-filter is not inoculated properly thereby creating more disinfection by-products than ever existed before ozonation.

### SUMMARY OF THE INVENTION

It is an object of the present invention is to provide processes and apparatus for treatment of water, and to treated water formed from such processes and apparatus.

It is another object of the present invention to provide effective, efficient and/or economically feasible processes and apparatus for removing TOC from drinking water so that the concentration of TOC left in the drinking water is less than 2 ppm, and to treated water made therefrom.

It is even another object of the present invention to provide economically feasible processes and apparatus for removing the DOC component of TOC from drinking water so that the concentration of DOC left in the drinking water is less than 2 ppm, and to treated water made therefrom.

It is still another object of the present invention to provide an economically feasible process for removing all components of TOC from drinking water so that the concentration of TOC left in the drinking water is less than 2 ppm without causing a significant risk of waterborne disease in the final water, and to treated water made therefrom.

It is yet another object of the present invention to provide processes and apparatus for utilizing known strain(s) of biological cultures to be inoculated and grown on biological filters in drinking water facilities that already operate with ubiquitous biological filters, and to treated water made therefrom.

It is even still another object of this invention to provide processes and apparatus for maintaining an active and viable biological population on biological filters in drinking water facilities, and to treated water made therefrom.

It is even yet another object of the present invention to provide a cost effective biological processes and apparatus to control biological pathogens and viruses in drinking water, and to treated water made therefrom.

It is still even another object of the present invention to provide a biological processes and apparatus to improve control of taste and odor molecules in drinking water, and to treated water made therefrom.

It is still yet another object of the present invention to provide efficient and economical biological processes and apparatus to remove TOC, DOC and AOC, as well as toxic TOC molecules from drinking water in drinking water purification plants that utilize ozonation, and to treated water made therefrom.

It is yet even another object of the present invention to provide efficient and economical processes and apparatus to remove the disinfection by-products of ozonation from drinking water in drinking water plants that utilize ozonation, and to treated water made therefrom.

It is yet still another object of the present invention to provide processes and apparatus to perform coagulation and flocculation without pre-oxidation, opening the door for subsequent effective use of a bio-filter colonized with fermentation-raised bacteria, and to treated water made therefrom.

It is even still yet another object of the present invention to provide processes and apparatus to perform coagulation and flocculation, along with disinfection upstream of a bio-filter colonized with fermentation-raised bacteria so that the by-products of disinfection can be removed by a bio-filter colonized with fermentation-raised bacteria, and to treated water made therefrom.

It is even yet still another object of the present invention to provide efficient and economical processes and apparatus as alternatives to ozonation for the removal of TOC from drinking water, so that the concentration of TOC left in the drinking water is less than 2 ppm, and to treated water made therefrom.

These and other objects of the present invention will become readily apparent to one of ordinary skill in the art upon a review of this Specification, its drawings and claims.

Improved potable/drinking water treatment systems are presented. These systems improve drinking water purity. These systems can dramatically reduce in drinking water: Aluminum which is linked to Alzheimer's disease, disinfection by-products which are linked to cancer causing and to birth defect causing compounds, toxic organic compounds which can be poisonous or known carcinogenic compounds, and pathogens, as well as, viruses which are linked to waterborne disease.

An improved bio-filter system is presented for purifying potable water comprising locating at least one bio-filter structure upstream of a disinfecting unit in a potable water purifying plant and colonizing fermentation-raised bacteria on or within the at least one bio-filter structure and including the at least one bio-filter structure having the fermentation-raised bacteria.

Improved potable water treatment processes are presented comprising the elimination of oxidation/disinfection prior to coagulation. Improved potable water treatment processes are presented utilizing oxidation/disinfection with ozone in the purifying process upstream of bio-filtration. Biofiltration is then followed by final filtration and final disinfection.

By utilizing a new coagulation technology, separation of solids (including the IOC component of TOC) from potable water is improved. This new coagulation technology is preferred to be used along with ozonation upstream of bio-filter(s) colonized with fermentation-raised bacteria. This new coagulation technology is most preferred to be used with the new bio-filter(s) colonized with fermentation-raised bacteria replacing ozonation.

Should ozonation be used, the improved bio-filter system colonized with fermentation-raised bacteria is capable of significantly removing TOC, including DOC, many toxic TOC compounds and MTBE, along with the disinfection by-products of ozonation, aldehydes and ketones.

The improved bio-filter system is capable of significantly removing many toxic TOC, as well as DOC, molecules from the water while reducing the concentration of many naturally occurring pathogens and viruses form the water.

Comparisons between the current art and the proposed bio-filter present five topics of further discussion: 1. Bio-chemical pathways and final products, 2. Identification of bacterial blends, 3. Final filter life utilizing a bio-filter, 4. Disinfectant usage with a bio-filter, and 5. Potable water effects utilizing a bio-filter in the case of a final filter turbidity breakthrough in combination with a loss of disinfection.

The bio-chemical pathway is, generally:

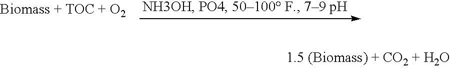

The biochemical pathway removes TOC by biological consumption of the TOC. Further, as long as the TOC is a consumable substrate, that is to say a consumable food source, the biomass will consume TOC in direct proportion to the available biomass and the available kinetics to bring the TOC in contact with the biomass. Therefore, the bio-chemical pathway inherently does not produce toxic by-products. An incomplete bio-chemical pathway can produce products that are partially converted to carbon dioxide and water; however, selection of the appropriate strains of bio-cultures, potentially selectively culturing the bio-cultures, providing oxygen and nutrients, and designing the appropriate reaction kinetics can assure near complete conversion of TOC to carbon dioxide and water. The only exceptions to this rule would be extremely toxic substrates such as transformer oils and halogenated organic molecules.

Bio-cultures are to be selected depending on the substrates, the TOC and the DOC components of TOC, in the raw water. Specific strains are known to break specific molecular bonds; this can be further classified to the breaking of specific molecular bonds on certain substrates. Therefore, a blend of bio-cultures is designed to provide bio-chemical pathways for all of the anticipated substrates in the raw water. Often, for toxic substrates, the bio-cultures are selectively cultured for that toxic substrate. Selective culturing is the process of continuously providing a specific substrate to a biological strain or a blend of biological strains, usually in a laboratory environment, through many generations. After many generations, when the consumption of that substrate is acceptable, the strains are “Selectively cultured on that specific substrate.” In the case of Thiobacillus and Thiobacillus Denitrificanus, these strains convert sulfides to elemental sulfur within the biomass. Therefore, in the situations where the raw water has taste and odor issues and where some of those odor issues are related to sulfur, the bacterial blend would contain a mixture of heterotrophs for TOC removal, along with Thiobacillus and/or Thiobacillus Denitrificanus for sulfide removal.

Final filter life and the available flow of water through the final filter are anticipated to increase, utilizing the bio-filter upstream of the final filter. This is because the bio-filter would act as a pre-filter for the final filter removing particulate matter that would otherwise normally channel the filter media reducing filter life. In addition, the bio-filter will remove many IOC components that would otherwise collect in the final filter. Finally, to the extent that the biomass of the bio-filter will be mesophilic heterotrophs operating under a low Food to Mass (F/M) ratio, the biomass will secrete a polysaccharide causing the biomass to cling to each other and cling to the structure of the bio-filter between filter washings. Therefore, given all considerations, the bio-filter is anticipated to increase final filter life and available plant throughput. Field evaluations in Beaumont support these anticipated results.

Disinfectant usage will decrease with the bio-filter. The bio-filter will decrease disinfectant usage due to three factors: 1. The fermentation-raised heterotrophs used to inoculate the bio-filter will digest, consume, much of the ubiquitous bacteria in the raw water, thereby removing a significant amount of the disinfection requirement, 2. The fermentation-raised heterotrophs used to inoculate the bio-filter are much larger than their ubiquitous counterparts are. Therefore, unless there is a filter breakthrough, very little of the heterotrophic colonies are expected to pass through the final filter, and 3. Since, the bio-filter will reduce the available TOC molecules, which are the available biological substrates, food sources, in the storage tanks and in the distribution system, the bacterial populations in the storage tanks and in the distribution system will be significantly reduced. Bacterial populations exist in direct proportion to available substrates. A significant reduction in the bacteria in the storage tanks and in the distribution system means less disinfectant required.

Should the heterotrophic inoculated bio-filter be used when there is a final filter turbidity breakthrough in combination with a loss of disinfectant, the fermentation-raised heterotrophic bio-cultures would present much less of a health risk than would either ubiquitous cultures or conventional filtration. This is because the fermentation-raised bio-culture colonies preferably would develop with known non-pathogenic strains that are known to be innocuous to humans. Therefore, these strains would present little to no harm. On the contrary, either ubiquitous biological filters or conventional filters can accumulate the pathogens that exist in the raw water; breakthroughs under the existing scenarios present greater health concerns.

The bio-filter, even though rather complex to understand at first, will make a novel and dramatic improvement in potable water quality. The bio-filter, by removing the production of carcinogens and teratogens from potable water while reducing the risk of pathogens in potable water, is a significant improvement in water treatment.

These and other embodiments of the present invention will become readily apparent to one of ordinary skill in the art upon a review of this Specification, its drawings and claims.

According to one embodiment of the present invention, there is provided a process for modifying a potable water purifying plant defining a process flow path in which water to be treated travels through a number of units including at least a last disinfection unit. The process includes positioning a bio-filter structure, suitable for the colonizing of fermentation-raised bacteria, in the flow path at a point in the process flow path prior to the disinfection unit.

According to another embodiment of the present invention, there is provided a process for operating a potable water purifying plant defining a process flow path in which water to be treated travels through a number of units including at least a last disinfection unit, the process includes introducing fermentation-raised bacteria into the process flow path at a point in the process flow path prior to the disinfection unit.

According to even another embodiment of the present invention, there is provided a potable water purifying plant comprising one or more units defining a process flow path in which water to be treated travels including at least a last disinfection unit, and fermentation-raised bacteria residing within process flow path at a point in the process flow path prior to the disinfection unit.

According to still another embodiment of the present invention, there is provided a bio-filter system for purifying potable water. The system includes bio-filter structure especially adapted for positioning upstream of a last disinfecting unit in a potable water purifying plant, wherein the structure is suitable for colonizing fermentation-raised bacteria on or within the bio-filter structure.

According to yet another embodiment of the present invention, there is provided a a process for the clarification of a liquid containing particles. The process includes contacting together the liquid, aluminum polymer and at least one additional polymer selected from the group consisting of ammonium polymers and polyacrylamide polymers, to coagulate particles and to form a flocculated suspension of the particles and the liquid. The process further includes separating the liquid from the flocculated suspension to create a settled liquid, and then contacting the settled liquid with fermentation-raised bacteria to create colonized liquid.

According to even still another process for the clarification of water containing particles. The process includes contacting together the water, aluminum polymer and at least one selected from the group consisting of ammonium polymers and polyacrylamide polymers, to coagulate particles and to form a flocculated suspension of the particles and the water, and then separating the water from the flocculated suspension to create a settled water, and then contacting the settled water with a non-ubiquitous fermentation-raised bacteria for removal of Total organic carbon, including dissolved organic carbon.

The timing of the present invention is significant because the EPA is requiring a significant increase in the TOC removal at drinking water facilities. The EPA is requiring removal of DOC as a component of TOC. Many facilities are having difficulty meeting the DOC removal component of the new TOC removal regulations.

### BRIEF DESCRIPTION OF THE DRAWINGS

A better understanding of the present invention can be obtained when the following detailed description of the preferred embodiments are considered in conjunction with the following drawings, in which:

FIG. 1 illustrates in block diagram form a conventional or traditional potable water treatment system;

FIG. 2 illustrates in block diagram form an ozonated water production or potable water treatment system utilizing ubiquitous bio-filters of the conventional art;

FIG. 3 illustrates in block diagram form a most preferred embodiment of the instant invention utilizing bio-filters inoculated with fermentation-raised biocultures; and,

FIG. 4 illustrates in bock diagram form a preferred embodiment of the instant invention with ozonated water treatment upstream of the bio-filters inoculated with fermentation-raised bio-cultures.

### DETAILED DESCRIPTION OF THE INVENTION

In this invention, fermentation-raised bacteria, preferably non-pathogenic and typically cultured, are disclosed and taught to be effectively used, preferably along with oxygen, nitrogen and phosphate compounds, to build and maintain a biological filter to remove primarily the DOC form, and secondarily some IOC form, of TOC from potable water in a potable water purification plant. The advantages of using fermentation-raised bacteria are: the bacteria can be selected and, if necessary, selectively cultured, to remove a variety of specific toxic TOC(s) in the system; the filter structure can be backwashed and cleaned with chlorinated or disinfected water since a full growth of the bacteria can be replaced immediately on the filter structure; the mass of the bacteria colony can be quickly increased to meet increased demand; studies indicate fermentation-raised bacteria will out compete ubiquitous pathogenic bacteria for available substrates; studies indicate fermentation-raised bacteria will potentially digest the ubiquitous pathogenic bacteria and viruses; ozone specific “disinfection by-products” can be significantly reduced; and the cost of an ozone system can be eliminated.

By performing TOC removal to a remaining concentration of 2 ppm or less in the water prior to disinfection, the presence of toxic TOC(s) and the formation of “disinfection by-products” can be significantly reduced. Combining new coagulation technology with a non-ubiquitous, bio-filter inoculated with fermentation-raised biocultures should largely obviate any need for pre-oxidation. Pre-oxidation with halogens can produce difficult to consume substrate(s) for a bio-filter.

It should be understood that a water treatment facility may include disinfection at more than one location in the water treatment process. This disinfection will occur in a disinfection unit (otherwise known as a stages, process or zone). In any even, there will always be a “final” disinfection, either a one and only disinfection (in which case it is not only the first but the last disinfection), or either the last of a number of disinfection units.

In the practice of the present invention, the bio-filtration is conducted anytime prior to the last disinfection.

The present invention provides a process for the treatment of water using an improved bio-filter to remove TOC from the water, and in many cases, to remove certain pathogens and viruses from the water. A “non-ubiquitous” biological filter is added to the water production facility. This non-ubiquitous biological filter can provide health benefits to users of the final drinking water by reducing TOC as well as the DOC component of the TOC. By reducing TOC, the non-ubiquitous biological filter will reduce precursors to “disinfection by-products”; many of these by-products are known or suspected carcinogens and/or teratogens. By reducing TOC, the non-harmful bacteria of the biological filter will also reduce biological substrates, food sources for any potentially harmful bacteria occurring in the storage tanks and in the distribution system. By reducing the food sources for bacteria and viruses in the storage tanks and in the distribution system downstream of the purification plant filter, the biological filter can allow for a reduction in the amount of disinfectant added to the water. Reducing the amount of disinfectant added to the water, in turn, again reduces the potential concentration of “disinfection by-products” in delivered water from the distribution system.

The most preferred method of the instant invention would be to perform colonization of a bio-filter structure with fermentation-raised non-pathogenic bacteria to perform biological filtration after separation or clarification and before final filtration. This most preferred process would be to alter the current water production process to: 1. Pre-treatment, 2. Coagulation, 3. Flocculation, 4. Separation, 5. pH adjustment and biological nutrient addition, if required, 6. Non-ubiquitous biological filtration, 7. Disinfection before and/or after final filtration, 8. Final filtration, and 9. Storage.

A preferred method of the instant invention would be to perform colonization of a bio-filter structure with fermentation-raised non-ubiquitous bacteria to perform biological filtration in water that has been ozonated upstream in the purification process. In this preferred method, it is preferred to perform this bio-filtration after separation or clarification and before final filtration. This preferred process would be to alter the current water production process to: 1. Pre-treatment with ozonation, 2. Coagulation, 3. Flocculation, 4. Separation, 1A. Secondary ozonation 5. pH adjustment and biological nutrient addition, if required, 6. Non-ubiquitous biological filtration, 7. Disinfection before and/or after final filtration, 8. Final filtration, and 9. Storage.

Many facilities do prefer to begin disinfection in separation to obtain CT Credits with a weaker disinfectant that is also a weaker neucleophile; this practice has the an additional benefit of controlling algal growth in the separation equipment, thereby further controlling “Taste & Odor” issues in the final water. While the addition of chlorine and chloramines are commonplace disinfectants in separation, their associated disinfection by-products are more difficult to remove biologically. It is well documented in the biological literature that chlorinated hydrocarbons are difficult substrates for any biological species. In addition, while disinfection could be easily accomplished in separation in combination with a biological filter downstream of separation by simply controlling the concentration of the disinfectant leaving separation, the formation of chlorinated hydrocarbons as disinfection by-products in separation potentially creates further disinfection by-products that are difficult to remove in any biological filter.

An alternate disinfectant in separation that would remove pathogens and control algae while not producing halogenated disinfection by-products is Hydrogen Peroxide (H₂O₂). H₂O₂ is a disinfectant that will not form halogenated disinfection by-products. Further, hydrogen peroxide has more oxidation potential than does ozone. The final products of a bacteriological reaction with H₂O₂ are primarily dead bacteria, oxygen and water; further, the resultant dissolved oxygen can be used by the biological filter. The reaction of H₂O₂ with organic molecules produces alcohols and glycols, which are AOC molecules. Hydrogen peroxide is also a good oxidizer to convert sulfides to sulfate, thereby improving “Taste & Odor” issues.

While alcohols and glycols are the desired products of ozonation, ozone (O₃) also produces aldehydes and ketones. Ozone does not produce halogenated disinfection by-products. Again, neither does hydrogen peroxide. Therefore, a preferred embodiment, for those facilities that prefer to oxidize or disinfect upstream of a bio-filter, is to oxidize or disinfect with at least one of ozone or hydrogen peroxide upstream of bio-filter(s) colonized with fermentation-raised bacteria. Further, hydrogen peroxide is a preferred oxidant or disinfectant prior to TOC removal in a bio-filter, if a disinfectant is to be used prior to TOC removal in a bio-filter.

The attached four Figures and their associated discussion further illustrate prior art and preferred embodiments of the instant invention.

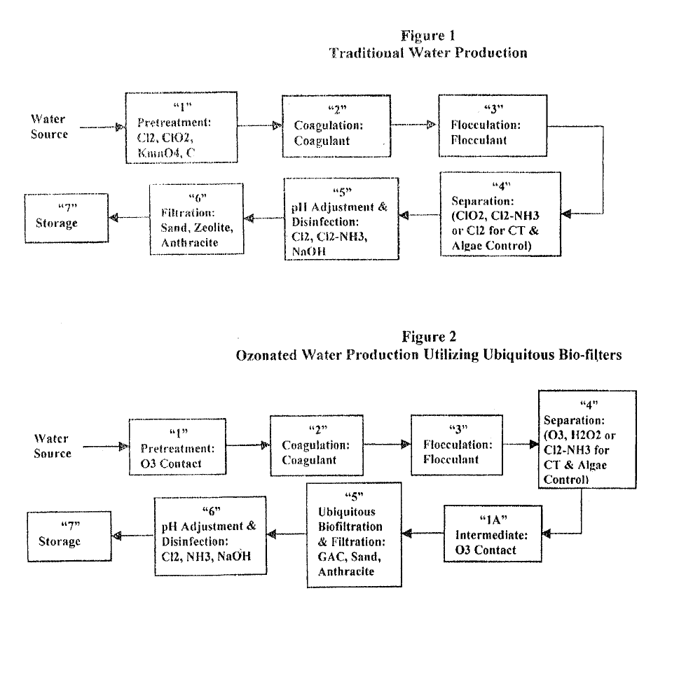

To refer to the figures, FIG. 1 illustrates in block diagram form a traditional or convention potable water production or treatment system.

In stage 1, pre-chlorination is not required with newer coagulation technology. Chlorine (Cl2) is often added near the raw water source to oxidize sulfides to sulfate and oxidize organics for removal. If Cl2 were added, this location would begin a significant conversion of TOC (IOC and DOC) molecules to disinfection byproducts. TOC molecules would convert to halogenated organics. Potassium Permanganate (KMnO4) and Carbon (C) are often added to remove taste and odor molecules such as MIB and Geosmine. Often, aeration is performed to oxidize sulfides to sulfate.

In stage 2, coagulant is added in a high turbulent zone termed the rapid mix. Traditionally, Aluminum and Iron salts are used. Frequently those salts would be used along with low molecular weight polyquatemary amines. Newer coagulation technology may be added at this point instead of metal salts. With the new coagulation technology, nearly all of the IOC molecules are combining in the floc, along with NTU and color removal.

In stage 3, infrequently, a flocculant is added in the form of a polyquatemary amine or an anionic polyacrylamide. Infrequently, pH adjustment is performed to create hydroxide floc minimizing flocculant addition. With the new coagulation technology, nearly all of the IOC molecules are removed in the floc, along with NTU and color.

In stage 4, separation normally occurs via gravity settling. Separation can occur via filtration or centrifugation. Frequently, Cl2 is added or Cl2 and Ammonia (NH3) are added to form Chloramines for disinfection and to control algal growth in the clarifier. With the new coagulation technology, nearly all of the IOC molecules are removed in the floc.

In stage 5, NaOH and/or Lime are added for pH adjustment. NaOH is preferred for filter life; Lime is preferred for chemical cost and protection of distribution piping. Cl2 is added or Cl2 and NH3 are added to create Chloramines for disinfection. Chloramines are preferred to minimize the formation of disinfection by-products. Remaining TOC molecules begin converting to halogenated disinfection by-products.

In stage 6, with new coagulation technology, the remaining IOC molecules are removed in the filter media. Utilizing metal salts, some of the IOC molecules may pass through the filter media. DOC molecules, and potentially IOC molecules if metal salts are used, continue through the filter for conversion to halogenated disinfection by-products.

In stage 7, storage and distribution are effected. DOC molecules, and any IOC molecules from metal salt coagulation, continue conversion to halogenated disinfection by-products.

FIG. 2 illustrates in block diagram form a conventional ozonated potable water production or treatment system utilizing ubiquitous bio-filters.

In stage 1, this step is not required with newer coagulation technology. Ozone (O3) is added to convert TOC (IOC and DOC) molecules to alcohols and glycols (AOC molecules that are also DOC molecules). As they enter the plant, TOC molecules can be toxic or non-toxic. If pre-ozonation is performed, a fraction of the IOC and DOC molecules convert to aldehydes and ketones which are Toxic DOC molecules being disinfection byproducts. Ozone oxidizes sulfides, MIB and Geosmine; therefore, no other pre-treatment is used.

In stage 2, coagulant is added in a high turbulent zone termed the rapid mix. Traditionally, Aluminum and Iron salts are used. New coagulation technology may be added at this point instead of metal salts; this new coagulation technology does not require O3 pretreatment.

In stage 3, when using metal salts as the coagulant, a flocculant is added in the form of a polyquaternary amine, which must be used to control clarifier-settling velocities. The majority of the IOC molecules are combined with NTU and color in the floc.

In stage 4, separation normally occurs via gravity settling. Separation can occur via filtration or centrifugation. With newer coagulation technology, nearly all of the IOC molecules are removed in the floc. Pre-ozonation is commonly used. A disinfectant may be used for disinfection and/or to control algal growth in the clarifier. While traditional disinfectants are not used at this step in a plant that utilizes ozonation in the treatment process, if pre-ozonation is not used or if algae is a problem in the clarifier, hydrogen peroxide would be a preferred disinfectant to: control algae, provide disinfection contact time, minimize disinfection by-products and help to provide oxygen for the bio-filter. Again, if pre-ozonation were not used or if algae is a problem in the clarifier, the combination of Chlorine and Ammonia to create Chloramines would be preferred as Chloramines have a much less propensity to create chlorinated disinfection by-products than does Chlorine. It would not make sense to use Chlorine at this stage with an ozonator on site. If disinfection is performed at this stage, the disinfectant must be low enough at the exit so as not to kill the bacteria in the bio-filter.

In stage 1A, if biological filters are used, a second O3 contact chamber is used to provide oxygen in the water and attempt complete conversion of the remaining TOC, primarily DOC molecules to alcohols and glycols (which are also AOC and DOC molecules). A fraction of the DOC molecules convert to aldehydes and ketones which are Toxic DOC molecules being disinfection byproducts.

In stage 5, biological filtration is performed with “Ubiquitous” biological filters usually on a GAC substrate. The filters are inoculated with available bacteria from “4”, Separation. No nutrients are added. No biological cultures or enzymes are added other than those available from Separation. AOC molecules are removed “to the extent that the filter is inoculated”. In the same filter assembly, NTU removal, final color removal and remaining IOC removal are performed with Anthracite, sand, Zeolite or membranes. DOC molecules that were not converted to AOC molecules, including any that are Toxic pass through filters.

In stage 6, NaOH and/or Lime are added for pH adjustment. Lime is preferred for chemical cost and protection of distribution piping. Cl2 is added or Cl2 and NH3 are added to create Chloramines for disinfection. Chloramines are preferred to minimize the formation of disinfection by-products. DOC molecules, including AOC molecules and Toxic DOC molecules, begin converting to halogenated disinfection by-products.

In stage 7, storage and distribution are effected. The DOC molecules continue conversion to halogenated disinfection by-products.

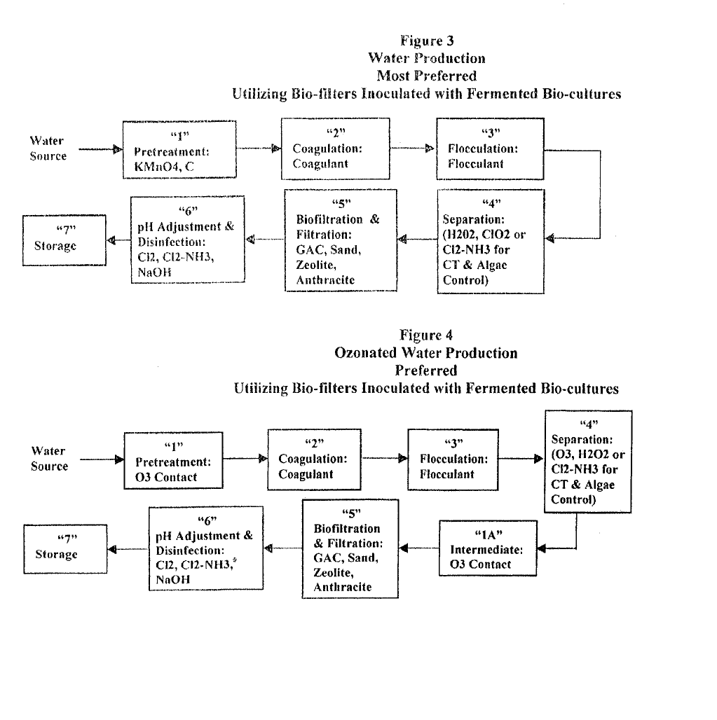

FIG. 3 illustrates a preferred embodiment of a potable water treatment system or water production plant utilizing bio-filters inoculated with fermentation-raised biocultures.

In stage 1, KMnO4 and C may be added, if desired, to remove taste and odor molecules such as MIB and Geosmine. Often, aeration is performed to oxidize sulfides to sulfate.

In stage 2, coagulant added in a high turbulent zone termed the rapid mix. Traditionally, Aluminum and Iron salts are used. New coagulation technology is most preferred to be added at this point instead of metal salts. With the new coagulation technology, nearly all of the IOC molecules are combining in the floc, along with NTU and color.

In stage 3, infrequently a flocculent is added in the form of a polyquaternary amine or an anionic polyacrylamide. Infrequently, pH adjustment is performed to create hydroxide floc minimizing flocculant addition. With the new coagulation technology, nearly all of the IOC molecules are removed in the floc, along with NTU and color.

In stage 4, separation normally occurs via gravity settling. Separation can occur via filtration or centrifugation. With the new coagulation technology, nearly all of the IOC molecules are removed in the floc. Frequently, Cl2 is added or Cl2 and NH3 to form Chloramines. Chlorine dioxide, ClO2, is sometimes used; however, ClO2 is the most expensive. Either system is used for disinfection and/or to control algal growth in the clarifier. Hydrogen peroxide would be a preferred disinfectant to: control algae, provide disinfection contact time, minimize disinfection by-products and help to provide oxygen for the bio-filter. The combination of Chlorine and Ammonia to create Chloramines would be preferred as Chloramines have a much less propensity to create chlorinated disinfection by-products than does Chlorine. ClO2 would be preferred as ClO2 has a very low propensity to create halogenated disinfection by-products; however, in some waters, ClO2 can create disinfection by-products of oxides of Chlorine. Oxides of Chlorine other than ClO2 need to be avoided. Some facilities may prefer to use Chlorine; however, due to Chlorine's propensity to create chlorinated disinfection by-products, Chlorine is not preferred. If disinfection is performed at this stage, the concentration of the disinfectant must be managed low enough at the exit of this stage so as not to kill the bacteria in the bio-filter.

In stage 5, biological filtration is performed utilizing “Fermentation-raised non-pathogenic bio-cultures.” Nutrients and oxygen are added, if necessary. pH adjustment is performed, if necessary. DOC and a portion of the IOC molecules are removed. Downstream, either in the same filter assembly or in another piece of equipment, NTU, color and nearly all of the remaining IOC molecules are removed with Anthracite, Zeolite, sand or membrane filters.

In stage 6, NaOH and/or Lime are added for pH adjustment. Lime is preferred for chemical cost and distribution pipe protection. Cl2 is added or Cl2 and NH3 are added to create Chloramines for disinfection. Chloramines are the most preferred to minimize the formation of disinfection by-products. Little to no TOC precursors (IOC or DOC) remain on which to form disinfection by-products.

In stage 7, storage and distribution are effected.

FIG. 4 illustrates a preferred embodiment of the present invention including an ozonated water production or potable water treatment system utilizing bio-filter(s) inoculated with fermentation-raised biocultures.

In stage 1, this step is not required with new coagulation technology. Ozone, O3, is added to convert TOC (IOC and DOC) molecules to alcohols and glycols (AOC molecules that are also DOC molecules). As the TOC molecules enter the plant, the molecules can be toxic or non-toxic. If pre-ozonation is used, a fraction of the IOC and DOC molecules convert to aldehydes and ketones which are Toxic DOC molecules being disinfection byproducts. Ozone oxidizes sulfides, MIB and Geosmine; therefore, no other pre-treatment is normally used.

In stage 2, coagulant is added in a high turbulent zone termed the rapid mix. Traditionally, Aluminum and Iron salts are used. New coagulation technology is most preferred to be added at this point instead of metal salts; this new coagulation technology does not require O3 pretreatment.

In stage 3, a flocculant is added in the form of a polyquatemary amine to control clarifier-settling velocities. If new coagulation technology is used, a flocculant is normally not needed. The majority of the IOC molecules are combined with NTU and color in the floc.

In stage 4, separation normally occurs via gravity settling. Separation can occur via filtration or centrifugation. With the new coagulation technology, nearly all of the IOC molecules are removed in the floc. If pre-ozonation is not used, a disinfectant may be used for disinfection and/or to control algal growth in the clarifier. While traditional disinfectants have not been used at this step in concert with ozonation, if pre-ozonation is not used or if algae is a problem in the clarifier, hydrogen peroxide would be a preferred disinfectant to: control algae, provide disinfection contact time, minimize disinfection by-products and provide oxygen for the bio-filter. If pre-ozonation is not used or if algae is a problem in the clarifier, the combination of Chlorine and Ammonia to create Chloramines would be preferred as Chloramines have a much less propensity to create chlorinated disinfection by-products than does Chlorine. It would not make sense to use Chlorine at this stage with an ozonator on site. If disinfection is performed at this stage, the disinfectant must be low enough at the exit so as not to kill the bacteria in the bio-filter.

In stage 1A, a second O3 contract chamber is often used to provide oxygen in the water and attempt complete conversion of the remaining TOC, primarily DOC molecules to alcohols and glycols (which are also AOC and DOC molecules). A fraction of the DOC molecules convert to aldehydes and ketones which are Toxic DOC molecules being disinfection byproducts.

In stage 5, biological filtration is performed utilizing “Fermentation-raised non-pathogenic bio-cultures.” Nutrients and oxygen are added. pH adjustment is performed, if necessary. DOC, including the AOC and a portion of the remaining IOC molecules, are removed. Toxic ozonation disinfection by-products (those other than alcohols and glycols) are removed in the bio-filter. Downstream, either in the same filter assembly or in another piece of equipment, NTU removal, final color removal and nearly all of the remaining IOC molecules are removed with Anthracite, Zeolite, sand or membrane filters.

In stage 6, NaOH and/or Lime are added for pH adjustment. Lime is preferred for chemical cost and protection of distribution piping. Cl2 is added or Cl2 and NH3 are added to create chloramines for disinfection. Chloramines are preferred to minimize the formation of disinfection by-products. Little to no TOC precursors (IOC or DOC) remain on which to form disinfection by-products.

In stage 7, storage and distribution are effected.

Non-ubiquitous biological filtration before coagulation would be a possibility in some cases but not a practicality in most cases. Such biological filtration before coagulation could be used to remove BOD, COD or TOC. However, biological filtration before coagulation would not take advantage of the low turbidity water produced in coagulation, flocculation and separation. Therefore, the kinetics of TOC removal to less than 2 ppm could often be rather impractical prior to coagulation. As such, removal of DOC to concentrations of less than 2 ppm would be rather impractical. Further, biological filtration prior to coagulation could lead to ubiquitous colonies of waterborne disease along with the non-ubiquitous colonies in the biological filter. The ubiquitous colonies would arise from the ubiquitous bacteria in the raw water.

Non-ubiquitous biological filtration after final filtration is not an ideal choice, as there would be a heightened risk of bacteria in the final water. Final filtration provides one barrier to prevent bacteria in the final water. It has been proven by the USEPA that final water turbidities of less than 0.1 NTU nearly eliminate the risk of pathogenic or viral contamination and that final water turbidities of less than 0.3 NTU significantly reduce the risk of pathogenic or viral contamination In combination with the recommended and regulated final filter turbidities, the USEPA is recommending that the settled NTU, which is upstream of final filtration, be equal to or less than 2.0. The pathogens and viruses tested for removal by the USEPA are 1 to 3 microns in size. Good references for these relationships would be, “National Primary Drinking Water Regulations: Interim Enhanced Surface Water Treatment; Final Rule,” 40 CFR Parts 9, 141 and 142 and “Optimizing Water Treatment Plant Performance Using the Composite Correction Program,” by the USEPA.

Heterotrophic bacteria can be safely eliminated from the water supply with the same measures as those used for viral elimination. Namely, maintaining the final filter turbidity targets.

The use of fermentation-raised heterotrophic strains of biological cultures on a bio-filter provides additional barriers to bacteria in the final water. Heterotrophic bacteria are much larger in size than are their pathogenic or viral counterparts. While the viruses tested by the EPA are 1 to 3 microns in size, heterotrophic bacteria are 5 to 10 microns in size. Therefore, it will be much more difficult to pass the heterotrophic bacteria through the final filters. Finally, by maintaining a low Food Mass (TOC and incoming bacteria) to Biological Mass (Non-ubiquitous heterotrophic bacteria) Ratio (F/M Ratio), digestion of some of the incoming bacteria, whether pathogenic, viral or harmless, may occur. Under these same low (F/M) ratios, which are preferably less than 1.0, heterotrophic mesophilic bacteria naturally secrete a polysaccharide that causes the bacteria to either cling to each other or to a solid surface; this action permits the mesophilic heterotrophic bacteria to cling to media in a biological filter. Therefore, under the required conditions that permit the heterotrophic bacteria to cling to the biological filter, the heterotrophic non-ubiquitous bacteria will naturally digest some of the incoming ubiquitous bacteria. Therefore, the use of known strains of fermentation-raised heterotrophic biological cultures to inoculate a bio-filter can provide additional barriers to some of the viruses and to some of the pathogens in the final water.

Disinfection, either before or after final filtration, yet after biological filtration provides an additional barrier to bacteria in the final water.

Finally, TOC removal reduces the occurrence of bacteria and viruses in the storage tanks and in the distribution system. TOC is the substrate for the bacteria and the viruses in the storage tanks and in the distribution system.

Fermentation-raised biological cultures refer to biological cultures as those cultures would be raised or fermented or grown in a biological reactor/incubation device to increase biomass prior to inoculation, colonization, on the bio-filters. These cultures would be defined by species to be sure of their pathogenicity. These cultures could be selectively cultured to consume specific substrates, whether those substrates are TOC or DOC. Further, many otherwise toxic TOC substrates can be selectively cultured. These cultures could be grown on-site prior to inoculation to minimize the amount of bacteria to be shipped to the site.

To insure that water borne diseases do not colonize on the biological filter, a regular cleaning of the biological filter with chlorinated water followed by a re-inoculation of the filter with known strain(s) of fermentation-raised bacteria may be performed.

Non-ubiquitous biological filtration of the instant invention is to be accomplished utilizing known strains, and preferably non-pathogenic strains, and most preferably heterotrophic non-pathogenic strains, raised or grown in a fermentation device in order to control the colonies that are inoculated on the biological filter. Preferably only species that are placed into the bacterial fermentation process are to be provided to the non-ubiquitous biological filter of the water production plant. Some suitable strains of bacteria that are viable for the biological filter are: Acinobactor, Nitrobactor, Enterobactor, Thiobacillus and Thiobacillus Denitrificanus, Pseudomonas, Escherichia, Artobactor, Achromobactor, bdellovibrio, Thiobacterium, Macromonas, Bacillus, Cornebacterium, Aeromonas, Alcaligenes, Falvobacterium, Vibrio and fungi. Enzymes may be used; however, while enzymes increase biological effectiveness, enzymes reduce the biological efficacy of the cultures. Therefore, enzymes are not preferred. In addition, since enzymes can be less than 1 micron in size, enzymes are not as desirable as bacterial cultures, as some enzymes could pass through the final filter. The above list is indicative of the strains that can be used; the list is not to be restrictive of the strains that can be used. However, in the event of a final filter turbidity breakthrough in combination with a loss of disinfectant, it is preferred that the strains be free of any viral or pathogenic properties.

Whereas, Thiobacillus and Thiobacillus Denitrificanus do not remove TOC, Thiobacillus and Thiobacillus Denitrificanus can remove sulfides. Thiobacillus Denitrificanus, as well as many Denitrificanus species under low dissolved oxygen conditions (approximately <0.6 ppm), can also remove oxides of nitrogen, such as nitrous oxide, nitrite or nitrate. While sulfides present water with an objectionable odor, Geosmine and MIB can present water with objectionable taste and odor. Since Geosmine and MIB are TOC molecules, blends of the above strains with Thiobacillus Denitrificanus can be used to specifically reduce objectionable taste and odor, as well as oxides of nitrogen, if needed.

The non-ubiquitous biological filter can have many physical configurations. A preferred filter will operate efficiently and effectively with media to provide a surface area for the growth of bacterial colonies along with the kinetics to bring the TOC within the water in contact with the bacteria. The biological filter structure can be a contact tower or any vessel supporting the contact media. The biological filter could be a portion of the final filter media providing a pretreatment step to final filtration. The biological filter could reside in the exit trough of the clarifier or sedimentation basin. The media of the biological filter can be any non-contaminating media with media of a high surface area to volume ratio preferred. Preferred materials for the media would be Granular Activated Carbon (GAC) or Silica. GAC is the most preferred media, since GAC has a high surface area to volume ratio, is light enough to stay on the top of most filter designs through many backwash cycles and is relatively inexpensive. It is important that the media be so designed that the bacterial colonies have a surface area to adhere and colonize while providing the kinetics for the bacteria to consume TOC from the water. Prior to coagulation, an aeration basin or activated sludge design may be employed; however, it would be more difficult to clean an aeration basin or activated sludge system and re-inoculate. Because of cleaning and inoculation, it is preferred to use a “contact media type” biological filter prior to coagulation, if it is desired to use a biological filter prior to coagulation.

To insure that the bacterium maintains viability, it may be necessary to add nitrogen compounds to the water in the form of either ammonia or nitrogen salts. Nitrogen is an important nutrient for the bacteria. It may also be necessary to add phosphates to the water in the form of either phosphoric acid, phosphate salts or polymers of phosphate. Phosphate is an important nutrient for the bacteria. The ammonia and phosphate can be added individually or together, either directly to the bio-filter or upstream of the bio-filter. Ammonia and phosphates are currently NSF listed chemicals for drinking water facilities.

Bacteria are pH sensitive. The required pH range is approximately 6.5 to 9.5 with the optimum range approximately 7.0 to 9.0. Thus, pH adjustment of the water may be required upstream of the bio-filter to maintain proper pH for the bacteria.

Mesophilic bacteria operate per the Arrhenius equation in relation to temperature with an effective operating temperature range of approximately 50 F to 100 F. Therefore, should the water temperature drop significantly, it may be necessary to re-inoculate or provide an easily consumable substrate to increase the biomass, size of the bacterial population. Thermophiles do operate above 105 F; however, it is impractical to heat large quantities of water to such a temperature. Therefore, mesophilic bacteria are preferred.

Bacteria also require one pound of oxygen for approximately every pound of TOC consumed. It may be necessary to add oxygen or air directly to the bio-filter or to the water upstream of the bio-filter. Aeration is a preferred method that is inexpensive and practical.

It is important that the bio-filter not become septic. Septicity is defined as a dissolved oxygen content in the water of 0.3 ppm or less. Should a bio-filter not have enough oxygen and become septic, naturally occurring Sulfite Reducing Bacteria (SRB's) could begin to occupy the filter. While SRB's can remove TOC, SRB's produce sulfides in the water. Sulfides are slightly toxic and have an objectionable odor. It is preferred to maintain a dissolved oxygen content of approximately greater than 0.5 ppm in the bio-filter.

Finally, to minimize biological expense during filter inoculation, it may be preferred by some facilities to add a co-substrate, food source, along with the inoculation or to grow the cultures on a co-substrate before inoculation, during inoculation or during operation. Co-substrates could rapidly increase bacterial colony population on the media while reducing the expense of biological cultures. Co-substrates utilized could vary in type and in amount; however, it would be preferred to use a non-toxic substrate that would easily be removed by the final filter.

In the selection of a co-substrate, it is desired that the bacteria thrive with the understanding that certain co-substrates suitable for the bacteria are either themselves undesirable in water or could produce undesirable by-products in the water. Thus, care should be taken in the selection of a co-substrate that allows the bacteria to thrive and yet is not undesirable and/or does not overly contribute to the generation of undesirable by-products in the water (preferably will not generate essentially no undesirable by products).

For example, aliphatic hydrocarbons or aliphatic alcohols could be utilized, but are the precursors to monitored disinfection by-products, and thus are not preferred.

Preferred co-substrates include sugars, for example at least one selected from the group of monosaccharides, acid modified monosaccharides, alditols, dissaccharides, polysaccharides, and combinations thereof. More preferred co-substrates are selected from among glucose, sucrose, and fructose.

New Coagulation Technology—Removing the Need for Pre-oxidation

In drinking water production, coagulants play an essential role. Aluminum salts (AS's), such as aluminum sulfate and aluminum chloride, have been used for decades as chemicals to clean water. In recent years, Aluminum polymers (AP's), such as aluminum chlorohydrate, poly-aluminum chloride, sulfated polyaluminum hydroxy chloride and poly-aluminum siloxane sulfate, have also been used in chemical water treatment. Recently, the sulfated versions of aluminum polymers have been employed for cold temperature performance. However, while each of these AP's have the ability to clean water with a lower dosage than that required with AS's, these AP's create a very small floc as compared to that available with the AS's. Moreover, floc carryover increases the TOC loading or F/M ratio of a bio-filter; therefore, reducing the carryover improves the DOC removal capability of a bio-filter.

Performances of chemical sites that are formed for microfloc formation during coagulation prior to a flocculation growth stage vary with alkalinity. These microfloc chemical sites are critical in the chemical cleaning of the water with iron salts or aluminum salts, as well as to a lesser extent with aluminum polymers. It is well known to a person skilled in the art of water treatment that significantly greater chemical dosages are typically needed for the clarification of water with low alkalinity than for the clarification of water with higher alkalinity. It is also well known that the removal of color and TOC from the raw water is much more difficult than is the removal of turbidity. Often, when the raw water color and TOC contents are high, >150 apparent color units (ACU) and >8 ppm, respectively, it is difficult to form a microfloc; this treatment difficulty is compounded in low alkalinity water. Meanwhile, a maximum color content for settled and filtered water is established by the government (as stated on p. 30 of CH-290 Water Hygiene). A color content of at most 15 standard color units (SCU) in the final filtered water must be achieved.

Pre-oxidation, whether ozonation, chlorination, or chlorine dioxide is known and used to assist salts in forming a microfloc. Pre-oxidation treatment can assist the formation of microfloc sites lowering the salt dosage in most raw waters. Pretreatment or enhanced treatment of the raw water with chlorine creates disinfection by-products, tri-halo-methanes (THM) being one group that are known cancer-causing chemicals. Another group of disinfection by-products, halo-acetic acids (HAA(s)) are known birth defect forming chemicals. Halogenated disinfection by-products are difficult for any bio-filter to remove, as are all halogenated organic molecules. Until recently, many water treatment plants were still pre-chlorinating. At present, there are THM and HAA regulations that nearly eliminate pre-chlorination activities, as stated on p. 15 of 146 of National Primary Drinking Water Regulations: Disinfectants and Disinfection Byproducts, Federal Register, 63 FR 69389-69476, published on Dec. 16, 1998, referred to as “NPDWR.” To stay within allowable THM and HAA guidelines, water production facilities must stop pre-chlorination and only perform post-clarifier/pre-filter or post-filter chlorination. Therefore, the capability of improving settled water and filtered water turbidities, TOC and color removal by pre-chlorination has been effectively outlawed by default.

The new process for clarification of raw waters by chemical treatment without pre-oxidation is focused on the application of at least one of a medium or a high or a very high molecular weight ammonium polymer (AmP) in combination with aluminum polymers (AP's) or AP's in concert with aluminum salts (AS's) to treat the water.

In the new coagulation technology blends of the materials always include a significant fraction of a medium or high or very high molecular weigh range of AmP or of a non-ionic polyacrylamide in the medium or high or very high molecular weight range, thereby providing a system that cleans raw waters without pre-oxidation. Improved water cleaning and flocculation performance is herein observed without pre-oxidation upon using DADMAC having a molecular weight of at least 500,000 and preferred 1,000,000 to about 5,000,000, with a 20% active product, at viscosities of about 500 cps and preferred 1,000 cps to 5,000 cps.

The new coagulation technology includes processes and improved processes for clarifying waters and for removing the IOC contaminants of TOC without the need for pre-oxidation. Aluminum polymers (AP) such as poly-aluminum hydroxychloride, poly-aluminum chloride, sulfated polyaluminum hydroxy chloride and poly-aluminum siloxane sulfate are combined with formulated medium, high and very high molecular weight ammonium polymers (AmP), such as di-allyl di-methyl ammonium chloride (DADMAC), epi-chlorohydrin di-methylamine (Epi-DMA) and polymers based upon amino-methacrylate polyacrylamide chemistry, to significantly improve liquid-solid separation in drinking water clarification.

Aluminum polymer (AP) is used herein and below to refer to an aluminum polymer or polyaluminum composition such as aluminum chlorohydrate, aluminum hydroxychloride, polyaluminum chloride, polyaluminum hydroxysulfate, polyaluminum hydroxy chlorosulfate, polyaluminum chlorosulfate calcium chloride, a polyaluminum hydroxy “metal” chloride and/or sulfate, or a polyaluminum “metal” chloride and/or sulfate, and the like.

Medium, high or very high molecular weight AmP (M/H/VH MW AmP) can be medium or high molecular weight DADMAC, medium or high molecular weight Epi-DMA, and medium, high or very high molecular weight amino-methacrylated polyacrylamides. Medium to high or very high molecular weight non-ionic polyacrylamides may be used in some situations. Often, medium to high to very high anionic polyacrylamides can be used just downstream of an AP or of an AP/AmP or of an AP/AmP(s) combination. Very high molecular weight DADMAC and Epi-DMA do not exist at this time. Off-the-shelf cationic polyacrylamide is actually a VH MW Amp. It is reasonable to believe that an MMW and HMW polyacrylamide would perform similarly to the respective MMW and HMW DADMAC and Epi-DMA. An H/VH MW Amp should be understood below to include the very high molecular weight polyacrylamides together with the HMW Amp's. Medium molecular weights are included because those of skill in the art will realize, and limited tests indicate, that in some circumstances, in some raw waters, a medium molecular weight AmP will perform equivalently or nearly equivalently to a high molecular weight AmP.

The optimal HMW AmP choice in a given circumstance may depend on the chemistry of the waters. If a polyacrylamide is used, the chemistry of the waters may determine that the optimum polyacrylamide be cationic, non-ionic or anionic. The combination of AP and AmP may be further enhanced by blending the AP/AmP(s) with an aluminum salt (AS). The AmP may be enhanced by blending with other medium, high or very high molecular weight AmP's and/or with low molecular weight quaternized ammonium polymers, such as DADMAC or Epi-DMA.

Due to the nature of water chemistry, as it is understood by those knowledgeable in the art, those known as water technologists, successful and optimal coagulants and/or chemical treatments for raw water and equipment combinations can only be determined by testing on the raw water. The industry established test is the jar test. The jar test is a reliable and established method of determining an optimal and successful coagulant and/or chemical treatment when the test has been properly designed to match plant equipment constraints.

It should be understood, however, that not all possible individual combinations of AP and AmP would perform equally, optimally and/or as successfully in all raw waters. As individuals have individual fingerprints, raw waters are chemically unique in their respective contaminants, constituents and/or properties. Thus, water technologists know that testing is required to determine optimal and successful blends for different raw water and equipment combinations.

Definitions and terminology established herein will govern the meaning of terms herein and below to the extent that there is any inconsistency.

In the following, the below definitions will be utilized:

Low molecular weight: 20K-250K (20 to 250 cps @ 20% active in water and 40 to 1,000 cps @ 50% active in water)

Medium molecular weight: 500K-1,000K (500 to 1,000 cps @ 20% active in water and 2,000 to 5,000 cps @ 50% active in water)

High molecular weight: 1000K-5,000K (1,000 to 5,000 cps @ 20% active in water and >5,000 cps @ 50% active in water)

Very high molecular weight: >5,000K (defined by individual intrinsic viscosity)

Preferred cationic monomers for AmP polyacrylamides are dialkylaminoalkyl (meth)-acrylates and -acrylamides, generally as acid addition or quaternary ammonium salts, and diallyl dialkyl ammonium halides. The preferred acrylates and methacrylates are preferably di-C₁₋₄ alkylaminoethyl (meth) acrylates and the preferred acrylamides are di-C₁₋₄ alkylaminopropyl (meth) acrylamides, in particular dimethylaminoethyl (meth) acrylate and dimethylaminopropyl (meth) acrylamide (with the respective acrylate and the respective acrylate and methacrylamide compounds being particularly preferred) as acid addition and quaternary ammonium salts. For most purposes the most suitable cationic monomer is a dialkyl quaternary salt, preferably dimethyl ammonium chloride. Generally a single cationic monomer is used, but if desired a copolymer may be formed, for instance from diallyl dimethyl ammonium chloride and dimethylaminopropyl methacrylamide salt, generally with the latter in a minor proportion.

Instead of forming the coagulant polymer by addition polymerization of ethylenically unsaturated monomers, any other known ionic coagulant polymers can be used. For instance suitable polymers are polyethylene imine and polyamines, e.g., as made by condensation of epichlorhydrin with an amine. Other polymers include aminomethylolated polyacrylamide (free base or quaternary or acid salt), poly(acryloxyethyltrimethylammonium chloride), poly(2-hydroxyporpyl-1-N-methylammonium chloride), poly(2-hydroxy-propyl-1, 1-N-dimethylammonium chloride, poly(acryloyloxyethyl diethylmethyl ammonium chloride and poly(2-vinylimidazolinum bisulfate). Mannich polymers may be used; however, stability is normally a concern.

Vinyl polymers having water solubility and cationic characteristics, as described above, include modified polyacrylamides, modification being made, for example, by the typical Mannich reaction products or the quaternized Mannich reaction products known to the artisan, or other vinylic polymers which use as a vinyl monomer those monomers containing functional groups which have cationic character. As an example, but not meant to be limiting on this invention, we include in these types of vinyl monomers such monomers as AETAC, APTAC, DMAEM, DMAEM DMS quat., DACH HCl, DADMAC, DMAEA, MAPTAC, METAMS, AMPIQ, DEAEA, DEAEM, MAEAcAm, DMAEMAcAM, DEAEcAm, DEAEAcAm, and ALA, the quaternized compounds containing the polymers, polymers containing diallydimethylammonium chloride monomer, and the like. To be effective these additive polymers, be they condensation polymers or vinyl polymers, must have a medium, high or very high molecular weight. A preferred polymer is a condensation polymers derived from the reaction of epichlorohydrin dimethylamine.

| | |
|---|---|
| AETAC = | Methacryloyioxyethyltrimethyl ammonium |
| | chloride |
| APTACE = | Acryloyloxyethyltrimethyl ammonium |
| | chloride |
| DMAEM = | Dimethylaminoethylmethacrylate |
| DMAEM DMS quat. = | Dimethylaminoethylmethacrylate |
| | quaternized with dimethyl sulfate |
| DACHA HCl = | Diallylcyclohexylaminehydrochloride |
| DAMAC = | Diallyldimethylanimonium chloride |
| DMAEA = | Dimethyl amino ethyl acrylate and/or |
| | its acid salts |
| MAPTC = | Acrylamidopropyltrimethyl ammonium |
| | chloride |
| METAMS = | Methacrylamidopropyltrimethyl ammonium |
| | chloride |
| AMPIQ = | 1-acrylamido-4-methyl piperazine |
| | (quaternized with MeCl, MeBr, or Dimethyl |
| | Sulfate) |
| DEAEA = | Dimethylaminoethylacrylate and/or its acid |
| | salts |
| DEAEM = | Dimethylaminoethylmethacrylate and/or its |
| | acid salts |
| DMEAcAm = | Dimethylaminoethylacrylamide and/or its |
| | acid salts |
| DMAEMAcAm = | Dimethylaminoethylmethacrylamide |
| DEAEAcAm = | Diethylaminoethylacrylamide and/or its |
| | acid salts |
| DEAEMAcAm = | Diethylaminoethylmethacrylamide and/or |
| | its acid salts |
| ALA = | Allyll amine |

The new coagulation technology further provides a process for turbidity reduction, along with IOC and color removal, that combines AP's or AP's in combination with AS's with medium, high or very high molecular weight AmP's. Improved turbidity reduction by removing IOC's without chlorine pre-oxidation allows for improved TOC removal across bio-filters. Operation without halogenated disinfection by-products produced upstream of bio-filtration allows for greater TOC removal in bio-filtration since halogenated organic molecules are difficult substrates for bio-filtration.

Polyacrylamides, either AmP or non-ionic, are to be added along with the other components as part of the coagulation or flocculation stage. If an anionic polyacrylamide is used, the addition of the anionic polyacrylamide must be after the addition of the AP or after the combination of AP with AmP(s) or after the combination of AP with Amp(s) and AS. Cationic or non-ionic polyacrylamides are preferably a part of a blend in combination with AP or AP with AS. The process may be further enhanced by adding low molecular weight DADMAC and/or low molecular weight Epi-DMA. The addition of aluminum chloride can provide enhanced color and IOC reduction, while the addition of low molecular weight Epi-DMA and/or low molecular weight DADMAC can increase the effectiveness of the aluminum polymers at turbidity reduction. Blends of medium or high or very high molecular weight AmP's and low molecular weight DADMAC and/or low molecular weight Epi-DMA with at least one aluminum salt and/or at least one aluminum polymer have provided satisfactory results.

Blends of the medium or high or very high molecular weigh AmP's (including of course the polyacrylamides) with AmP's and/or AS's in the present invention are aimed at significantly improving the coagulation and the flocculation capability of the chemical compounds. Blends of a medium or a high or very high molecular weight AmP or polyacrylamide with at least one AP or an AP/AS combination have provided satisfactory results, even for raw unclarified water with alkalinity of less than 50 ppm. A preferred combination of the new coagulation chemistry is a blend of a medium or high molecular weight DADMAC, Epi-DMA and/or a high or very high molecular weight polyacrylamide with aluminum chlorohydrate (AlₓOH_{y}Cl_{z}). Blends of medium or high molecular weight DADMAC and/or Epi-DMA with (AlₓOH_{y}Cl_{z}) and/or AS have also been successfully applied. Blends of medium or high molecular weight DADMAC and/or Epi-DMA and/or medium, high or very high molecular weight polyacrylamides with AlₓOH_{y}Cl_{z} and/or AS provide a system that minimizes carryover and cleans many raw waters much more efficiently and effectively without the need for pre-oxidation.

Further, blends of at least one medium, high and/or very high molecular weight AmP with at least one low molecular weight quaternized ammonium polymer and with at least one AS and/or at least one AP have provided acceptable results while simultaneously causing the coagulation of algae from raw water. A preferred embodiment is a blend of a high molecular weight DADMAC or Epi-DMA and/or high or very high molecular weight polyacrylamide with at least one AS and/or at least one AP. The AS's preferably alums, aluminum chlorides or any combination thereof.

With embodiments of the new coagulation chemistry, it has been discovered that color units, turbidity units, the IOC portion of TOC, disinfection byproducts and aluminum content are lowered more easily and more efficiently. With embodiments of the new coagulation chemistry, it has been found that bio-filters operate more effectively. There is improved coagulation and an increase in the size of flocs, resulting in cleaner water along with higher rates of floc settlement than rates available for flocs using the lower molecular weight AmP's. The increase in coagulation and in the floc size is particularly significant when the high molecular weight and/or very high molecular weight AmP is used in combination with AP's in low alkalinity and low turbidity water.

Since pre-oxidation is done to assist aluminum and iron salts to perform micro flocculation, the use of medium, high and/or very high MW AmP's in combination with AP or AP and AS can eliminate the need for pre-ozonation, thereby significantly reducing the need for ozonation in general, further reducing costs and eliminating the disinfection byproducts of ozonation. If pre-ozonation is used, the use of medium, high and/or very high MW AmP's in concert with AP or AP and AS can improve liquid solid separation performance thereby improving the performance of the bio-filters.

In all cases tested, the new coagulation technology produces filtered water that is less than 0.2 mg/L Aluminum; often the Aluminum left in the water is non-detect.

### EXAMPLES

The following examples are provided merely to illustrate a few of the embodiments of the present invention, and are not meant and do not limit the scope of the claims of the invention.

### Example 1 (City of Beaumont Tex.)

The City of Beaumont, Tex. operates a Pulsation Clarifier System. The primary coagulant is currently alum. Raw water values are typically 20 to 25 ppm of alkalinity, 8 ppm of calcium, 40 to 60 NTU, 40 to 80 Standard Color Units and 5 to 12 ppm of TOC. An anionic polyacrylamide is used in emulsion form at a dosage of 0.2 to 0.4 mg/L to control pin-floc carryover and floc size. To improve THM and HAA control, as well as improve TOC removal, the City of Beaumont operates a ubiquitous biological filter. Beaumont does not perform ozonation. Beaumont operates the ubiquitous biological filter by adding a disinfectant, chlorine, after filtration rather than before.

To demonstrate the new biological filter concept: a 3-inch diameter filter column was installed. A metering pump to control clarified water flow to the column was installed, along with a pinch valve dropper system to control NaOH, H3PO4 and NH4OH addition to the clarified water metered to the column. Air stones were installed at the clarified water intake to the metering pump to increase the dissolved oxygen of the clarified water metered to the column.

The filter column was operated over a 4-month period. The first two months of operation were utilized to optimize the column operation. The column was not installed with a head loss pressure control loop; therefore, turbidity removal results could be significantly improved with normal operation of a final filter. The filter column had supporting gravel in the base. On top of the supporting gravel was 12-inches of filter sand. On top of the sand was installed 20-inches of filter anthracite. On top of the anthracite was installed 6-inches of GAC. The filter had a loading rate of approximately 3 gpm per square foot. H3PO4 and NH4OH were added to the clarified water metered to the filter; both were added at a concentration of 1.5×10⁻⁷ mg/L. This concentration was chosen to approximate a mass ratio of TOC/NH3OH/H3PO4 of 100/2-5/2-5. The clarified water metered to the filter was pH adjusted to approximately 7.0-7.5. The filter was backwashed with chlorinated water when the final NTU exceeded 0.3. The filter backwash rate was approximately 0.7 gpm per square foot. After each backwashing, the filter was inoculated with 1 oz of ClearValue Bio-Filter 100. ClearValue Bio-Filter 100 is a blend of heterotrophs dried on bran to a cell count of 6×10⁹ CFU per gram. The ClearValue Bio-Filter 100 was added by wetting the dried cultures for 15 minutes in 1 quart of non-chlorinated water while aerating the water with an air stone. After 15 minutes of aeration, the water was filtered with cheesecloth; the filtrate was poured onto the top of the filter column.

Operation of the bio-filter began during July of 1999. Filter design and operation was finally optimized, without a head loss control loop, in September of 1999. Operation to “Spend” the GAC began on Sep. 13, 2000 and ended on Oct. 2, 2000. The column was first inoculated on Oct. 2, 2000. Column bio-filtration results were accumulated from Oct. 6, 2000 through Oct. 25, 2000. The operation ended on Oct. 25, 2000.

Bio-filter Test Operational Data

| | | | Post | | Comments and |
|---|---|---|---|---|---|
| | Clarified | Post GAC | Media | Raw | TOC Removal |
| Date | NTU TOC | NTU TOC | NTU TOC | TOC | Percentages |
| 7/00 | ≈0.5 | N/A | ≈0.4 | N/A | 0.1 |
| to | | | | | to |
| 9/13/00 | | | | | 0.5 |
| | | | | | N/A |
| | | | | | N/A Two months |
| | | | | | operation required |
| | | | | | to develop an |
| | | | | | operating filter. |
| 10/02/00 | 0.5 | 2.1 | 0.4 | 2.0 | 0.32.0 |
| | | | | | 3.8 Over 2 weeks |
| | | | | | operation required |
| | | | | | to “Spend” the |
| | | | | | GAC before CV |
| | | | | | Bio-Filter. |
| 10/06/00 | 0.5 | 2.4 | 0.3 | 2.0 | 0.22.05.060% vs. |
| | | | | | plant 40% |
| | | | | | removal |
| 10/09/00 | 4.1 | 2.6 | 0.6 | 3.1 | 0.12.74.032% vs. |
| | | | | | plant 25% |
| | | | | | removal, (As |
| | | | | | indicated by 4.1 |
| | | | | | NTU the plant |
| | | | | | was upset.) |
| 10/16/00 | 1.3 | 3.5 | 0.9 | 2.5 | 0.32.45.052% vs. |
| | | | | | plant 16% |
| | | | | | removal |
| 10/18/00 | 1.2 | 3.2 | 0.3 | 2.4 | 0.22.45.052% vs. |
| | | | | | plant 32% |
| | | | | | removal |
| 10/23/00 | 1.1 | 2.2 | 0.2 | 1.9 | 0.21.94.760% vs. |
| | | | | | plant 35% |
| | | | | | removal |
| 10/25/00 | 0.5 | 2.4 | 0.3 | 2.0 | 0.22.04.757% |
| | | | | | removal, plant |
| | | | | | N/A. Cell |
| | | | | | counts obtained |
| | | | | | post CV Bio- |
| | | | | | filter-no |
| | | | | | pathogens. |

### Example 2 (City of Arlington, Tex.)

The city of Arlington, Tex. operates two drinking water production plants. The Pierce-Birch Plant and the John Kabala Plant. At the Pierce-Birch Plant, ozonation is used in combination with a ubiquitous bio-filter. Pre-ozonation is normally 0.6 to 0.8 mg/L of ozone. The intermediate contact chamber is normally 3 to 5 mg/L of ozone. Alum and a low molecular weight DADMAC are used as the coagulant and the flocculent, respectively. The Alum dosage ranges from 16 to 25 mg/L and the 40% LMW DADMAC is kept near 1 mg/L. Depending on the amount of pre-ozonation and the amount of Alum, the settled NTU will vary from approximately 1.5 to near 5. The filtered NTU will vary in concert with the settled NTU, from 0.10 to near 0.30.

Jar tests were performed with ozonated and non-ozonated water with CV1788, CV1754 and CV1120 in combination with CV5140DP. CV1788 is a blended product that is 80% CV1120, 10% CV3210 and 10% CV3650. CV1754 is ablended product that is 70% CV1120, 10% CV3650 and 10% CV3250. CV1120 is a 50% active Aluminum Chlorohydrate that is 24% Al203 and 84% basic. CV3210 is a 50% active Epi-DMA that is 100+/−20 cps. CV3650 is a 20% active DADMAC that is 2000+/−200 cps. CV3250 is a 50% active Epi-DMA that is 6000 to 11,000 cps. CV 5140DP is a dry cationic 40% active Q-9 polyacrylamide.

On Feb. 16, 2001, with a raw water NTU of 9, a jar test was performed per plant specifications having a 20-minute settling time. CV1754 produced 0.97 NTU at a dosage of 6.5 mg/L in non pre-ozonated water. That same day, utilizing the same testing sequence, CV1754 produced 0.82 NTU settled water at the same dosage in ozonated water. Also, on that same day CV1120 was jar tested in combination with CV5140P. The pre-ozonated water produced a 20 minute settled NTU of 1.2 with five mg/L of CV1120 and 0.10 mg/L of CV5140DP. The non-ozonated water produced a 20 minute settled NTU of 1.2 with 6.5 mg/L of CV1120 and 0.065 mg/L of CV5140DP. On that day, the plant operated near 2.6 settled NTU with 20 mg/L of Alum in pre-ozonated water.

### Example 3 (City of Arlington Tex.)

The city of Arlington, Tex. operates two drinking water production plants. The Pierce-Birch Plant and the John Kabala Plant. At the Pierce-Birch Plant, ozonation is used in combination with a ubiquitous bio-filter. Pre-ozonation is normally 0.6 to 0.8 mg/L of ozone. The intermediate contact chamber is normally 3 to 5 mg/L of ozone. Alum and a low molecular weight DADMAC are used as the coagulant and the flocculent, respectively. The Alum dosage ranges from 16 to 25 mg/L and the 40% LMW DADMAC is kept near 1 mg/L. Depending on the amount of pre-ozonation and the amount of Alum, the settled NTU will vary from approximately 1.5 to near 4. The filtered NTU will vary in concert with the settled NTU, from 0.10 to near 0.30.

A production trial was made of CV1788 during January of 2001. During this evaluation, CV1788 was run in concert with 0.6 mg/L of pre-ozonation. The pre-ozonation was not turned off because the cold dense water of January showed that 2 mg/L of CV1788 were required to replace the 0.6 mg/L of pre-ozone; therefore, the economics proved operation with pre-ozonation.

Operation with Alum prior to the start-up of CV1788 was at 16 mg/L and produced settled NTU's of 4 to 5. Operation with CV1788 at dosages of 7.5 to 9.0 mg/L produced settled NTU's of 1.5 to 3. The reduced carryover from the CV1788 proved to increase the efficiency of the ubiquitous bio-filters. Prior to operation with CV1788, and normal operation with Alum, produces a TOC removal of near 25%. During the CV1788, evaluation TOC removal increased to over 35%. Laboratory analysis on site identified, per the standard industry lab test, that the raw and final TOC is in excess of 90% DOC.

During the evaluation, filter hours increased from near 33 to near 60 hours.

### Example 4(City of Arlington)

The city of Arlington, Tex. operates two drinking water production plants. The Pierce-Birch Plant and the John Kabala Plant. At the John Kabala Plant, ozonation is used in combination with a ubiquitous bio-filter. Pre-ozonation is normally 0.8 to 1.2 mg/L of ozone. The intermediate contact chamber is normally 2 to 4 mg/L of ozone. Alum and a low molecular weight DADMAC are used as the coagulant and the flocculent, respectively. The Alum dosage ranges from 18 to 25 mg/L and the 40% DADMAC is kept near 1 mg/L. The settled NTU is normally near 1.5. The filtered NTU is normally near 0.20.

Repetitive jar tests performed at the John Kabala plant reveal CV1780 to be the optimal coagulant. CV1780 is a blended product that is 50% CV1120 and 50% CV3650. CV1120 is a 50% active Aluminum Chlorohydrate that is 24% Al203 and 84% basic. CV3650 is a 20% active DADMAC that is 2000+/−200 cps.

Settled NTU's of less than 1.0 are easily obtained at 5 to 6 mg/L in pre-ozonated water utilizing the standard plant testing sequence with a 15 minute settling time. The coagulation chemistry in this ozonated water proved very sensitive to the incorporation of the high molecular weight DADMAC. Reducing the DADMAC percentage in the blend by as little as 20% or including a lower molecular weight product, 400 cps at 20% active was tried, produced results that were over 4 and 5 NTU.

### Example 5 (City of Marshall???????????)

Marshall is currently in production with CV 1703. CV1703 is a blend that is by volume: 38% CV1120, 42% CV 1130, 8% CV 3210 and 12% CV3650. CV1120is an ACH measuring 24% Al203 at 84% basicity, CV1130 is an Aluminum Chloride solution that measures 10% Al203, CV3210 is a 50% active Epi-DMA solution that measures 100+/−20 cps, and CV3650 is a 20% active DADMAC solution that measures 2000+/−200 cps. Prior to using CV 1703, Marshall utilized CV 3650 in concert with alum. Alum was used at 30 to 35 ppm along with CV 3650 at 1.5 ppm.

Marshall's raw water quality makes production difficult:

The raw alkalinity is less than 20 ppm and often as low as 6 ppm,

The raw turbidity is normally 2 to 7 NTU and infrequently 10 to 15 NTU,

The raw color varies from 20 to 400 Apparent Color Units, and

The raw TOC ranges from 5 to 20 ppm, having a UV absorbency of 0.2 to 0.7 m⁻¹.

Prior to the use of CV 3650 with alum, Marshall operated with just alum and often went out of permit having a filtered water turbidity greater than 0.5 NTU; on Alum operation, Marshall frequently measured in excess of 0.02 mg/L of Aluminum in the final drinking water. CV 3650 in conjunction with alum improved operation significantly. However, at raw color values over 200 Standard Color Units, Marshall still had difficulties.

Prior to using CV 1703, Marshall produced filtered water at a turbidity of 0.15 to 0.30 NTU under normal conditions and higher when color was a challenge. Since operation with CV 1703, Marshall has had the ability to keep the filtered water turbidity under 0.08 NTU under all conditions. The settled water turbidity normally varies from 0.04 to 0.07 NTU. Per EPA guidelines, Marshall must remove, at times, 45% of the raw TOC and, at times, 50% of the raw TOC. During the year 2000, when the raw water has a lower organic content and nearly all of the raw TOC measures DOC per the standard industry test, Marshall is frequently unable to obtain 45% TOC removal. Operation during this time did not produce any final filtered water that had an Aluminum concentration over 0.2 mg/L.

On Aug. 15, 2000, laboratory testing was performed in Marshall to determine TOC and DOC removal, along with residual Aluminum concentrations. On this day the raw: NTU was 2.1, the ACU were 34, the UV absorbency was 0.21 m⁻¹ on both filtered and non-filtered samples indicated per industry definitions that all of the TOC was DOC; the alkalinity was 17 ppm. CV1787 was tested at dosages of 11 to 25 mg/L. CV1787 is a blend that is 85% CV1120 and 15% CV3250. CV3250 is a 50% active Epi-DMA solution that measures 6000 to 11,000 cps. Jar Test results ranged from: 0.47 to 0.62 NTU, 3 to 18 ACU and 0.079 to 0.122 m⁻¹. On a Hach DRC 2000, the Aluminum in the separated water was non-detect.

On Feb. 20, 2001, laboratory testing was performed in Marshall to determine TOC and DOC removal, along with residual Aluminum concentrations. On this day the raw: NTU was 13, the ACU were 160, the UV absorbency was 0.434 m⁻¹ on a non-filtered sample and the alkalinity was 17 ppm. CV1703 was tested at dosages of 27 to 40 mg/L. Jar Test results ranged from: 0.93 to 2.4 NTU, 9 to 23 ACU and 0.09 to 0.143 m⁻¹. On a Hach DRC 2000, the Aluminum was non-detect.

Certain objects are set forth above and made apparent from the foregoing description. However, since certain changes may be made in the above description without departing from the scope of the invention, it is intended that all matters contained in the foregoing description shall be interpreted as illustrative only of the principles of the invention and not in a limiting sense. With respect to the above description the, it is to be realized that any descriptions, drawings and examples deemed readily apparent and obvious to one skilled in the art and all equivalent relationships to those described in the specification are intended to be encompassed by the present invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention. It is also to be understood that the following claims are intended to cover all of the generic and specific features of the invention herein described, and all statements of the scope of the invention, which, as a matter of language, might be said to fall in between.

What is claimed:

1. A process for modifying a potable water purifying plant defining a process flow path in which water to be treated travels through a number of units including at least a last disinfection unit, the process comprising:
(A) positioning a bio-filter structure, suitable for the colonizing of fermentation-raised bacteria, in the flow path at a point in the process flow path prior to the disinfection unit.

2. The process of claim 1, wherein the bio-filter is suitable for the colonizing of fermentation-raised bacteria comprising non-pathogenic bacteria.

3. The process of claim 1, wherein the bio-filter is suitable for the colonizing of fermentation-raised bacteria comprising cultured, non-pathogenic bacteria.

4. The process of claim 1, wherein the biofilter comprises a co-substrate.

5. The process of claim 1, wherein the biofilter comprises a co-substrate selected from the group of sugars consisting of monosaccharides, acid modified monosaccharides, alditols, dissaccharides, polysaccharides, and combinations thereof.

6. The process of claim 1, wherein the bio-filter is suitable for the colonizing of fermentation-raised bacteria suitable for the removal of total organic carbon or dissolved organic carbon compounds.

7. The process of claim 1, wherein the bio-filter is suitable for the colonizing of at least one fermentation-raised bacteria selected from the group consisting of Acinobactor, Nitrobactor, Enterobactor, Thiobacillus and Thiobacillus Denitrificanus, Pseudomonas, Escherichia, Artobactor, Achromobactor, bdellovibrio, Thiobacterium, Macromonas, Bacillus, Cornebacterium, Aeromonas, Alcaligenes, Falvobacterium, Vibrio and fungi.

8. The process of claim 1, wherein the bio-filter is suitable for the colonizing of fermentation-raised bacteria suitable for removing methyl-tertiary-butyl-ether.

9. The process of claim, 1 further comprising:
(B) adding equipment suitable to provide ozone at a point in the process flow path prior to the bio-filter structure, and wherein the bio-filter is suitable for the colonizing of fermentation-raised bacteria suitable for removing total organic carbon, dissolved organic carbon, methyl-tertiary-butyl-ether and disinfection byproducts of ozonation.

10. The process of claim 1, further comprising:
(B) adding equipment suitable to provide at least one of hydrogen peroxide or chlorine dioxide at a point in the process flow path prior to the bio-filter structure, and wherein the bio-filter is suitable for the colonizing of fermentation-raised bacteria suitable for removing dissolved organic carbon or any other total organic carbon.

11. The process of claim 1, wherein the bio-filter is suitable for the colonizing of fermentation-raised bacteria suitable for removing organic toxins.

12. The process of claim 1, wherein the bio-filter is suitable for the colonizing of fermentation-raised bacteria suitable for removing pathogenic bacteria or viruses.

13. The process of claim 1, wherein the bio-filter is suitable for the colonizing of fermentation-raised bacteria suitable for removing sulfides.

14. The process of claim 1, further comprising:
(B) adding equipment suitable to provide nutrients and oxygen to the bio-filter structure.

15. A process for operating a potable water purifying plant defining a process flow path in which water to be treated travels through a number of units including at least a last disinfection unit, the process comprises:
(A) introducing fermentation-raised bacteria into the process flow path at a point in the process flow path prior to the disinfection unit.

16. The process of claim 15, wherein the fermentation-raised bacteria comprises non-pathogenic bacteria.

17. The process of claim 15, wherein the fermentation-raised bacteria comprises cultured, non-pathogenic bacteria.

18. The process of claim 15, wherein the fermentation-raised bacteria is suitable for the removal of Total organic carbon or dissolved organic carbon compounds.

19. The process of claim 15, wherein the fermentation-raised bacteria comprises at least one selected from the group consisting of Acinobactor, Nitrobactor, Enterobactor, Thiobacillus and Thiobacillus Denitrificanus, Pseudomonas, Escherichia, Artobactor, Achromobactor, bdellovibrio, Thiobacterium, Macromonas, Bacillus, Cornebacterium, Aeromonas, Alcaligenes, Falvobacterium, Vibrio and fungi.

20. The process of claim 15, wherein the fermentation-raised bacteria is suitable for removing methyl-tertiary-butyl-ether.

21. The process of claim, 15 further comprising:
(B) introducing ozone into the process flow path at a point in the process flow path before the introduction of the bacteria, wherein the fermentation-raised bacteria is suitable for removing Total organic carbon, dissolved organic carbon, methyl-tertiary-butyl-ether and disinfection byproducts of ozonation.

22. The process of claim 15, further comprising:
(B) introducing at least one of hydrogen peroxide or chlorine dioxide into the process flow path at a point in the path before the introduction of the bacteria, wherein the fermentation-raised bacteria is suitable for removing dissolved organic carbon or any other Total organic carbon.

23. The process of claim 15, wherein the fermentation-raised bacteria is suitable for removing organic toxins.

24. The process of claim 15, wherein the fermentation-raised bacteria is suitable for removing pathogenic bacteria or viruses.

25. The process of claim 15, wherein the fermentation-raised bacteria suitable for removing sulfides.

26. The process of claim 15, further comprising:
(B) providing nutrients and oxygen to the bacteria.

27. A process for operating a potable water purifying plant defining a process flow path in which water to be treated travels through a number of units including at least a last disinfection unit, the process comprises:
(A) maintaining fermentation-raised bacteria into the process flow path at a point in the process flow path prior to the disinfection unit.

28. The process of claim 27, wherein the fermentation-raised bacteria comprises non-pathogenic bacteria.

29. The process of claim 27, wherein the fermentation-raised bacteria comprises cultured, non-pathogenic bacteria.

30. The process of claim 27, wherein the fermentation-raised bacteria is suitable for the removal of Total organic carbon or dissolved organic carbon compounds.

31. The process of claim 27, wherein the fermentation-raised bacteria comprises at least one selected from the group consisting of Acinobactor, Nitrobactor, Enterobactor, Thiobacillus and Thiobacillus Denitrificanus, Pseudomonas, Escherichia, Artobactor, Achromobactor, bdellovibrio, Thiobacterium, Macromonas, Bacillus, Cornebacterium, Aeromonas, Alcaligenes, Falvobacterium, Vibrio and fungi.

32. The process of claim 27, wherein the fermentation-raised bacteria is suitable for removing methyl-tertiary-butyl-ether.

33. The process of claim, 27 further comprising:
(B) introducing ozone into the process flow path at a point in the process flow path before the introduction of the bacteria, wherein the fermentation-raised bacteria is suitable for removing Total organic carbon, dissolved organic carbon, methyl-tertiary-butyl-ether and disinfection byproducts of ozonation.

34. The process of claim 27, further comprising:
(B) introducing at least one selected from hydrogen peroxide or chlorine dioxide into the process flow path at a point in the path before the introduction of the bacteria, wherein the fermentation-raised bacteria is suitable for removing dissolved organic carbon or any other Total organic carbon.

35. The process of claim 27, wherein the fermentation-raised bacteria is suitable for removing organic toxins.

36. The process of claim 27, wherein the fermentation-raised bacteria is suitable for removing pathogenic bacteria or viruses.

37. The process of claim 27, wherein the fermentation-raised bacteria suitable for removing sulfides.

38. The process of claim 27, further comprising:
(B) providing nutrients and oxygen to the bacteria.

39. In a process for treating water to make it potable, including at least the step of a last disinfection, the improvement comprises contacting the water with fermentation-raised bacteria prior to disinfection.

40. The process of claim 39, wherein the fermentation-raised bacteria comprises non-pathogenic bacteria.

41. The process of claim 39, wherein the fermentation-raised bacteria comprises cultured, non-pathogenic bacteria.

42. The process of claim 39, wherein the fermentation-raised bacteria is suitable for the removal of Total organic carbon or dissolved organic carbon compounds.

43. The process of claim 39, wherein the fermentation-raised bacteria comprises at least one selected from the group consisting of Acinobactor, Nitrobactor, Enterobactor, Thiobacillus and Thiobacillus Denitrificanus, Pseudomonas, Escherichia, Artobactor, Achromobactor, bdellovibrio, Thiobacterium, Macromonas, Bacillus, Cornebacterium, Aeromonas, Alcaligenes, Falvobacterium, Vibrio and fungi.

44. The process of claim 39, wherein the fermentation-raised bacteria is suitable for removing methyl-tertiary-butyl-ether.

45. The process of claim, 39 further comprising:
contacting the water with ozone prior to contacting the water with the bacteria, wherein the fermentation-raised bacteria is suitable for removing Total organic carbon, dissolved organic carbon, methyl-tertiary-butyl-ether and disinfection byproducts of ozonation.

46. The process of claim 39, further comprising:
contacting the water with at least one selected from hydrogen peroxide and chlorine dioxide prior to contacting the water with the bacteria, wherein the fermentation-raised bacteria is suitable for removing dissolved organic carbon or any other Total organic carbon.

47. The process of claim 39, wherein the fermentation-raised bacteria is suitable for removing organic toxins.

48. The process of claim 39, wherein the fermentation-raised bacteria is suitable for removing pathogenic bacteria or viruses.

49. The process of claim 39, wherein the fermentation-raised bacteria suitable for removing sulfides.

50. The process of claim 39, further comprising:
providing nutrients and oxygen to the bacteria.

51. A potable water purifying plant comprising:
one or more units defining a process flow path in which water to be treated travels including at least a disinfection unit, and
fermentation-raised bacteria residing within process flow path at a point in the process flow path prior to the disinfection unit.

52. The potable water purifying plant of claim 51, wherein the fermentation-raised bacteria comprises non-pathogenic bacteria.

53. The potable water purifying plant of claim 51, wherein the fermentation-raised bacteria comprises cultured, non-pathogenic bacteria.

54. The potable water purifying plant of claim 51, wherein the fermentation-raised bacteria is suitable for the removal of Total organic carbon or dissolved organic carbon compounds.

55. The potable water purifying plant of claim 51, wherein the fermentation-raised bacteria comprises at least one selected from the group consisting of Acinobactor, Nitrobactor, Enterobactor, Thiobacillus and Thiobacillus Denitrificanus, Pseudomonas, Escherichia, Artobactor, Achromobactor, bdellovibrio, Thiobacterium, Macromonas, Bacillus, Cornebacterium, Aeromonas, Alcaligenes, Falvobacterium, Vibrio and fungi.

56. The potable water purifying plant of claim 51, wherein the fermentation-raised bacteria is suitable for removing methyl-tertiary-butyl-ether.

57. The potable water purifying plant of claim 51, wherein the fermentation-raised bacteria is suitable for removing Total organic carbon, dissolved organic carbon, methyl-tertiary-butyl-ether and disinfection byproducts of ozonation, the plant further comprising:
an ozone unit positioned to introduce ozone into the process flow path at a point in the process flow path before the introduction of the bacteria.

58. The potable water purifying plant of claim 51, wherein the fermentation-raised bacteria is suitable for removing dissolved organic carbon or any other Total organic carbon, the plant further comprising:
a unit positioned to introduce at least one of hydrogen peroxide or chlorine dioxide into the process flow path at a point in the path before the introduction of the bacteria.

59. The potable water purifying plant of claim 51, wherein the fermentation-raised bacteria is suitable for removing organic toxins.

60. The potable water purifying plant of claim 51, wherein the fermentation-raised bacteria is suitable for removing pathogenic bacteria or viruses.

61. The potable water purifying plant of claim 51, wherein the fermentation-raised bacteria suitable for removing sulfides.

62. The potable water purifying plant of claim 51, further comprising:
a nutrient and oxygen unit positioned to provide nutrients and oxygen to the bacteria.

63. A bio-filter system for purifying potable water, comprising:
a bio-filter structure especially adapted for positioning upstream of a last disinfecting unit in a potable water purifying plant, wherein the structure is suitable for colonizing fermentation-raised bacteria on or within the bio-filter structure.

64. The system of claim 63 wherein the fermentation-raised bacteria comprises strains of nonpathogenic bacteria.

65. The system of claim 63, wherein the structure comprises a biological reactor/incubator device suitable for colonizing the fermentation-raised bacteria.

66. The system of claim 63, wherein the fermentation-raised bacteria comprises bacteria selectively cultured to remove at least one specific Total organic carbon or dissolved organic carbon compounds.

67. The system of claim 63, wherein the fermentation-raised bacteria comprises at least one strain from the strains of Acinobactor, Nitrobactor, Enterobactor, Thiobacillus and Thiobacillus Denitrificanus, Pseudomonas, Escherichia, Artobactor, Achromobactor, bdellovibrio, Thiobacterium, Macromonas, Bacillus, Cornebacterium, Aeromonas, Alcaligenes, Falvobacterium, Vibrio and fungi.

68. The system of claim 63, wherein the fermentation-raised bacteria comprises bacteria which remove methyl-tertiary-butyl-ether from water.

69. The system of claim 63, wherein the fermentation-raised bacteria comprise bacteria which remove Total organic carbon, dissolved organic carbon, methyl-tertiary-butyl-ether and disinfection byproducts of ozonation, and further comprises an ozone structure suitable for adding ozone upstream of the bio-filter structure.

70. The system of claim 63, wherein the fermentation-raised bacteria comprise bacteria which remove Total organic carbon and dissolved organic carbon, and further comprises a structure suitable for adding at least one of hydrogen peroxide or chlorine dioxide upstream of the bio-filter structure.

71. The system of claim 63, wherein the fermentation-raised bacteria comprises bacteria to remove organic toxins from water being purified.

72. The system of claim 63, wherein the fermentation-raised bacteria comprise bacteria to remove pathogenic bacteria from water being purified.

73. The system of claim 63, wherein the fermentation-raised bacteria comprise bacteria to remove sulfides from water being purified.

74. The system of claim 1 that includes colonizing primarily non-ubiquitous fermentation-raised bacteria on the structure.

75. The system of claim 63, wherein the fermentation-raised bacteria is primarily non-ubiquitous.

76. A process for the clarification of a liquid containing particles, comprising:
contacting together the liquid, aluminum polymer and at least one additional polymer selected from the group consisting of ammonium polymers and polyacrylamide polymers, to coagulate particles and to form a flocculated suspension of the particles and the liquid;
separating the liquid from the flocculated suspension to create a settled liquid, and,
contacting the settled liquid with fermentation-raised bacteria to create colonized liquid.

77. The process of claim 76, further comprising filtering the colonized liquid to create final filtered water, and wherein the insoluble organic carbon content of the final filtered liquid is less than 2 mg/L.

78. The process of claim 76 further comprising filtering the colonized liquid to create final filtered water, and wherein the final filtered liquid comprises a measured aluminum content of less than 0.2 mg/L.

79. The process of claim 76 further comprising adding of aluminum salt to the liquid along with the aluminum polymer and additional polymer.

80. The process of claim 76 wherein the ammonium polymer comprises di-allyl di-methyl ammonium chloride.

81. The process of claim 76 wherein the ammonium polymer comprises epi-chlorohydrin di-methylamine.

82. The process of claim 76 wherein the polyacrylamide is a cationic or non-ionic polyacrylamide.

83. The process of claim 76 wherein the polyacrylamide is an anionic polyacrylamide.

84. The process of claim 76 wherein the aluminum polymer comprises polyaluminum hydroxychloride.

85. The process of claim 76 that includes an ozonation step prior to contacting the settled liquid with fermentation-raised bacteria

86. The process of claim 76 wherein the process is free of ozonation, and wherein the separation that removes turbidity, color and insoluble organic carbon from the liquid and that combines the turbidity, color and insoluble organic carbon into the flocculated suspension wherein in the separated water the turbidity is less than 2.0 and the color is less than 15 SCU.

87. A process for the clarification of water containing particles, comprising:
contacting together the water, aluminum polymer and at least one selected from the group consisting of ammonium polymers and polyacrylamide polymers, to coagulate particles and to form a flocculated suspension of the particles and the water;
separating the water from the flocculated suspension to create a settled water, and
contacting the settled water with a non-ubiquitous fermentation-raised bacteria for removal of Total organic carbon, including dissolved organic carbon.

88. The process of claim 87, further comprising filtering the colonized liquid to create final filtered water, and wherein the insoluble organic carbon content of the final filtered liquid is less than 2 mg/L.

89. The process of claim 87 further comprising filtering the colonized liquid to create final filtered water, and wherein the final filtered liquid comprises a measured aluminum content of less than 0.2 mg/L.

90. The process of claim 87 further comprising adding of aluminum salt to the liquid along with the aluminum polymer and additional polymer.

91. The process of claim 87 wherein the ammonium polymer comprises di-allyl di-methyl ammonium chloride.

92. The process of claim 87 wherein the ammonium polymer comprises epi-chlorohydrin di-methylamine.

93. The process of claim 87 wherein the polyacrylamide is a cationic or non-ionic polyacrylamide.

94. The process of claim 87 wherein the polyacrylamide is an anionic polyacrylamide.

95. The process of claim 87 wherein the aluminum polymer comprises polyaluminum hydroxychloride.

96. The process of claim 87 that includes an ozonation step prior to contacting the settled liquid with fermentation-raised bacteria

97. The process of claim 87 wherein the process is free of ozonation, and wherein the separation that removes turbidity, color and insoluble organic carbon from the liquid and that combines the turbidity, color and insoluble organic carbon into the flocculated suspension wherein in the separated water the turbidity is less than 2.0 and the color is less than 15 SCU.
